(19) United States
(12) Patent Application Publication
(10) Pub. No.: US 2004/0081844 A1
(43) Pub. Date: Apr. 29, 2004

(54) Method of making erasable articles and articles therefrom

(76) Inventors: Vivek Bharti, Cottage Grove, MN (US); Clinton L. Jones, Somerset, WI (US); Frederick J. Gustafson, Bloomington, MN (US)

Correspondence Address: 3M INNOVATIVE PROPERTIES COMPANY, PO BOX 33427, ST. PAUL, MN, 55133-3427, US

(21) Appl. No.: 10/645,714

(22) Filed: Aug. 21, 2003

Related U.S. Application Data
(63) Continuation-in-part of application No. 10/231,568, filed on Aug. 30, 2002.

(51) Int. Cl. B32B 5/16

(52) U.S. Cl. 428/523; 156/307.1; 428/515

(57) ABSTRACT

A method of making erasable article comprises: providing an electret film having first and second opposed major surfaces; applying a polymerizable precursor composition to at least a portion of the first major surface; polymerizing the polymerizable precursor composition to form a non-tacky crosslinked polymeric layer; and exposing the electret film and non-tacky crosslinked polymeric layer to a direct current corona discharge, wherein the second major surface is free of adhesive material. Erasable articles and kits containing them are also disclosed. Also disclosed are dry erase articles having a first coating layer coated onto a flexible substrate. The first coating composition has a hardness upon curing of greater than about 500 MPa and forms an ink receptive writing surface suitable for receiving dry erase marker ink. The first coating layer has minimal effect on the flexibility of the sheet.

### CROSS REFERENCE TO RELATED APPLICATION

This application is a continuation in part (CIP) of and claims priority to application Ser. No. 10/231,568 filed on Aug. 30, 2002 for “Method of Making Erasable Articles and Articles Therefrom” by Vivek Bharti, Clinton L. Jones, and Frederick J. Gustafson. The priority application is incorporated by reference in its entirety herein.

### TECHNICAL FIELD

The present invention relates to articles having an erasable writing surface.

### BACKGROUND

As commonly used, the term “dry erase” as applied to an article (e.g., a white board) refers to the ability to write or mark on that article with ink (e.g., using a felt tip marking pen), and later erase the ink without the need of a liquid cleaner. In practice, inks intended for use with dry erase surfaces are often specifically formulated for use with individual surface compositions, and may not be useful on all types of dry erase materials. Various dry erase articles are known, many of which are adapted to be mounted on a vertical surface using adhesive or mechanical fasteners (e.g., screws, nails, hooks, etc.). However, mechanical fasteners and many adhesives are unsuitable for uses in which repositioning of the dry erase article is desired. Further, adhesives may not adhere well to contaminated surfaces such as those contaminated with oil and/or dust particles.

Dry erase articles are known in the art generally as articles having surfaces that a user may write upon using ink markers. The user may then erase written indicia using an eraser (e.g. a cloth or a felt pad). Examples of dry erase surfaces include cured melamine resins, porcelain covered steel, fluoropolymer films, vinyl films, and ultraviolet radiation (UV) curable hardcoat films. Commercially available dry erase boards using cured melamine resins are manufactured by GBC Office Products, Skokie, Ill., Boone International, Corona, Calif., and RoseArt Company, Wood Ridge, N.J. Commercially available dry erase boards using porcelain covered steel are available from GBC Office Products and Boone International. Commercially available dry erase articles using fluoropolymer film can be obtained from Walltalkers, Inc., Fairlawn, Ohio. Vinyl dry erase articles are sold by Best-Rite Manufacturing, Temple, Tex. UV curable hardcoat film dry erase boards are commercially available from GBC Office Products and Boone International.

Using UV curable hardcoats to form dry erase articles has resulted in the ability to form articles that have a level of flexibility. Previously known dry erase articles that used UV curable hardcoats to provide a dry erase surface have not provided a high performance level. In particular, previous hardcoats which acceptably received the ink on the surface of the dry erase article resulted in poor “erasability” after aging of the writing on the dry erase surface, requiring repeated wiping with the eraser or even leaving ghost images of the indicia after repeated wiping with the eraser. One preferred method of erasing a dry erase article is to use a dry eraser. Ghost images of dry erase writing left after erasure require the application of liquid cleaners (e.g. water, household cleaners or solvent based dry erase cleaners).

The term “cling film” is commonly used to refer to a film that can cling to a substrate without the use of adhesives or fasteners. Cling films are generally divided into two major types: cling vinyl films and electret films.

Cling vinyl films (also known as “static cling vinyl” films) typically contain plasticizers and/or tackifiers, and can typically be adhered to smooth, rigid surfaces such as glass windows, but may not adhere well to porous, rough and/or dusty surfaces. In addition, plasticizers and/or tackifiers that are present in cling vinyl films may diffuse out of the film and leave a residue or on, or otherwise damage, a substrate to which the film is bonded.

In contrast, electret films (i.e., films having a permanent or semi-permanent electrostatic charge) typically adhere to surfaces by electrostatic attraction, typically do not require plasticizers or tackifiers, and may adhere well even to rough or dusty surfaces. Typically, such films are relatively inexpensive and can be repeatedly adhered to, and removed from (e.g., by peeling), surfaces without risk of leaving adhesive residue and/or physically damaging the substrate surface. Electret films typically outperform (e.g., with regard to duration of cling, resistance to humidity, and the like) films having mere surface charges (e.g., formed by contact charging). However, electret films may not erase well, with and/or without a liquid cleaner, if used with a variety of inks. That is, such films may leave traces of the ink image (i.e., ghosting), especially if used with ink not specifically adapted for use with the film.

It would be desirable to have erasable articles (e.g., films) that can be successfully marked and erased (e.g., dry erased) using a variety of inks, wherein the articles can be repeatedly adhered to, and removed from, a wide range of substrates by electrostatic attraction.

### SUMMARY

In one aspect, the present invention provides a method of making an erasable article comprising:

providing an electret film having first and second opposed major surfaces;

applying a polymerizable precursor composition to at least a portion of the first major surface;

polymerizing the polymerizable precursor composition to form a non-tacky crosslinked polymeric layer; and

exposing the electret film and non-tacky crosslinked polymeric layer to a direct current corona discharge,

wherein the second major surface is free of adhesive material.

In another aspect, the present invention provides an erasable article comprising an electret film having first and second opposed major surfaces, and a non-tacky crosslinked polymeric layer comprising contacting the first major surface, wherein the non-tacky crosslinked polymeric layer comprises colloidal silica, and wherein the second major surface is free of adhesive material.

In another aspect, the present invention provides an erasable article comprising an electret film having first and second opposed major surfaces, and a non-tacky crosslinked polymeric layer comprising contacting the first major surface, wherein the second major surface is free of adhesive material, and wherein the erasable article forms a roll.

In another aspect, the present invention provides a stack of erasable articles comprising a plurality of erasable articles superimposed on each other, wherein each erasable article comprises:

an electret film having first and second opposed major surfaces, and a non-tacky crosslinked polymeric layer comprising contacting the first major surface, wherein the second major surface is free of adhesive material.

In another aspect, the present invention provides an erasable article comprising:

an electret film having first and second opposed major surfaces, and a non-tacky crosslinked polymeric layer contacting the first major surface, wherein the electret film and wherein the second major surface is free of adhesive material; and

a liner, wherein the liner contacts the second major surface.

In another aspect, the present invention provides a kit comprising:

an erasable article, wherein the erasable article comprises:

an electret film having a first major surface and a second major surface; and

a non-tacky crosslinked polymeric layer; and

at least one of a marker, eraser, or liquid cleaner.

Erasable articles of the present invention can typically be repeatedly adhered to, and removed from, a wide range of substrates by electrostatic attraction, and may typically be marked and erased (e.g., dry erased) using a variety of inks.

In another aspect, the present invention provides a dry erase article comprising:

a flexible sheet having a first surface;

a first coating layer disposed on the first surface having a hardness upon curing of greater than about 500 MPa;

a writing surface disposed on the first coating layer suitable for receiving dry erase ink; and

wherein the first coating layer has minimal effect on the flexibility of the sheet.

In another aspect, the present invention provides a dry erase article comprising:

a substrate having a first surface and a second surface;

a curable hardcoat layer secured to the first surface, the hardcoat layer including at least one multifunctional acrylate monomer, and inorganic oxide particles; and

a writing surface disposed on the curable hardcoat layer suitable for receiving dry erase marker ink, the writing surface having a 60 degree gloss value of greater than about 50 gloss units.

In another aspect, the present invention provides a method for forming a dry erase article in a continuous process comprising:

applying a curable hardcoat coating to a streaming or moving web of a flexible substrate; and

curing the coating at a curing station, wherein the cured coating had a hardness of 500 MPa or greater as measured by a nanoindenter; and

forming a writing surface on the hardcoat coating suitable for receiving dry erase ink.

As used herein:

“film” refers to a continuous nonporous thin layer, and includes for example, rolls, sheets, tapes, and strips;

“removably adhered” means separable by peeling, without substantial damage (e.g., tearing) to the objects being separated;

“(meth)acryl” includes acryl and methacryl; and

“ionomer” refers to a polymer having carboxyl groups wherein at least some of the acidic protons have been replaced (i.e., neutralized) by metal ions.

### BRIEF DESCRIPTION OF THE DRAWINGS

FIG. 1 is a cross-sectional view of an exemplary erasable article according to one embodiment of the present invention;

FIG. 2 is a perspective view of an exemplary erasable article in the form of a roll according to one embodiment of the present invention; and

FIG. 3 is a perspective view of an exemplary stack of erasable sheets according to one embodiment of the present invention.

FIG. 4 is a perspective view of one embodiment of the inventive dry erase article.

FIG. 5 is a cross-sectional view of one embodiment of the inventive dry erase article.

FIG. 5A is a cross-sectional view of a second embodiment of the inventive dry erase article.

FIG. 6 is a schematic view of one embodiment of the inventive process for making a dry erase article.

While the above-identified drawings set forth various embodiments of the present invention, other embodiments of the present invention are also contemplated, as noted in the discussion. This disclosure presents illustrative embodiments of the present invention by the way of representation and not limitation. Numerous other modifications and embodiments can be devised by those skilled in the art which fall within the spirit and scope of the principles of this invention.

### DETAILED DESCRIPTION

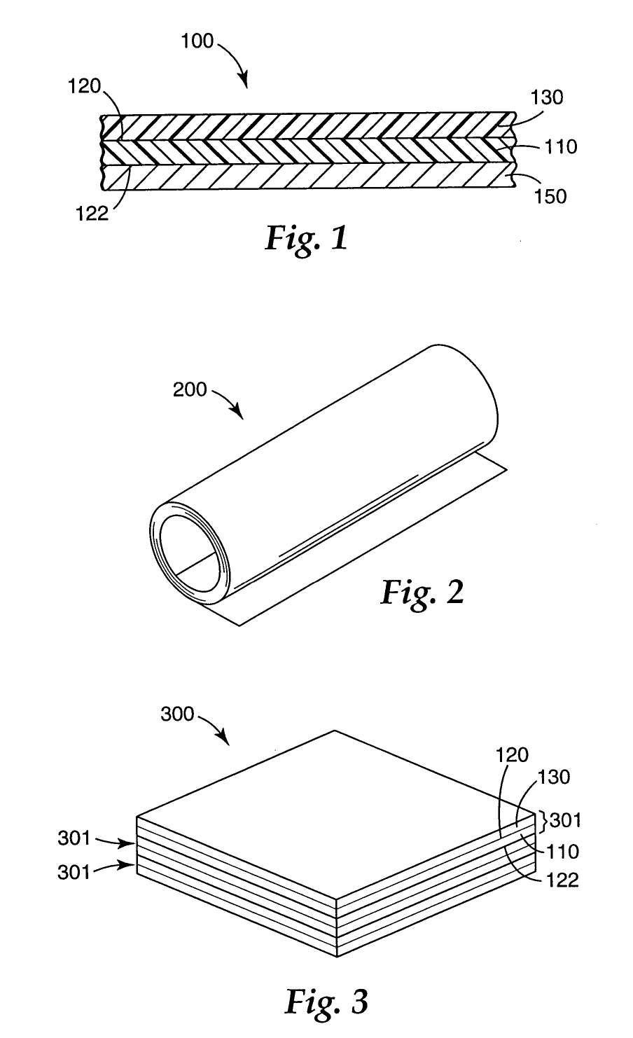

One exemplary embodiment of an erasable article according to the present invention is illustrated in FIG. 1. Referring now to FIG. 1, erasable article 100 has electret film 110 with first and second opposed major surfaces 120 and 122, respectively. Non-tacky crosslinked polymeric layer 130 contacts first major surface 120, and removable liner 150 contacts second major surface 122.

In one exemplary embodiment, erasable articles according to the present invention may be provided, as shown in FIG. 2, in the form of roll 200.

In one exemplary embodiment, erasable articles according to the present invention may be provided in the form of a stack of sheets as shown, for example, in FIG. 3, wherein stack 300 comprises a plurality of superimposed erasable articles 301. In this embodiment, each erasable article 301 independently comprises electret film 110 with first and second opposed major surfaces 120 and 122, respectively, and non-tacky crosslinked polymeric layer 130 which contacts first major surface 120.

Due to the inherent charge of the erasable articles, they typically self adhere to form a stack that may be handled as a single item.

Electret films, useful in practice of the present invention, typically comprise a thermoplastic polymeric material, optionally containing various fillers and additives.

Useful thermoplastic polymeric materials that can maintain an electret charge include fluorinated polymers (e.g., poly tetrafluoroethylene, polyvinylidene fluoride, tetrafluoroethylene-hexafluoropropylene copolymers, vinylidene fluoride-trifluorochloroethylene copolymers), polyolefins (e.g., polyethylene, polypropylene, poly-4-methyl-1-pentene, propylene-ethylene copolymers), copolymers of olefins and other monomers (e.g., ethylene-vinyl acetate copolymers, ethylene-acrylic acid copolymers, ethylene-maleic acid anhydride copolymers, propylene-acrylic acid copolymers, propylene-maleic acid anhydride copolymers, 4-methyl-1-pentene-acrylic acid copolymers, 4-methyl-1-pentene-maleic acid anhydride copolymers), ionomers (e.g., ethylene-(meth)acrylic acid copolymers with at least some acidic protons replaced by Na⁺, K⁺, Ca²⁺, Mg²⁺, or Zn²⁺ cations), polyesters (e.g., polyethylene terephthalate), polyamides (e.g., nylon-6, nylon-6,6), polycarbonates, polysulfones, non-plasticized polyvinyl chloride, blends and mixtures thereof, and the like. Preferably, the thermoplastic material comprises at least one of polypropylene or a poly(ethylene-co-methacrylic acid) ionomer, more preferably a poly(ethylene-co-methacrylic acid) ionomer, more preferably a zinc poly(ethylene-co-methacrylic acid) ionomer.

Many poly(ethylene-co-(meth)acrylic acid) ionomers are commercially available as pellets and/or films, for example, as marketed under the trade designation “SURLYN” (e.g., lithium poly(ethylene-co-methacrylic acid) ionomers such as “SURLYN 7930”, “SURLYN 7940”; sodium poly(ethylene-co-methacrylic acid) ionomers such as “SURLYN 1601”, “SURLYN 8020”, “SURLYN 8120”, “SURLYN 8140”, “SURLYN 8150”, “SURLYN 8320”, “SURLYN 8527”, “SURLYN 8660”, “SURLYN 8920”, “SURLYN 8940”, “SURLYN 8945”; zinc poly(ethylene-co-methacrylic acid) ionomers such as “SURLYN 1705-1”, “SURLYN 1706”, SURLYN 6101”, SURLYN 9020”, “SURLYN 9120”, “SURLYN 9150”, “SURLYN 9320W”, “SURLYN 9520”, “SURLYN 9650”, “SURLYN 9720”, “SURLYN 9721”, “SURLYN 9910”, “SURLYN 9945”, “SURLYN 9950”, “SURLYN 9970”, “SURLYN PC-100”) by E. I. du Pont de Nemours & Company, Wilmington, Del.; or as marketed under the trade designation “IOTEK” (e.g., sodium poly(ethylene-co-acrylic acid) ionomers such as “IOTEK 3110”, “IOTEK 3800”, or “IOTEK 8000”; and zinc poly(ethylene-co-acrylic acid) ionomers such as “IOTEK 4200”) by Exxon Mobil Corporation, Houston, Tex. Further details of useful poly(ethylene-co-(meth)acrylic acid) ionomers are described in, for example, commonly assigned U.S. patent application entitled “METHOD OF ADHERING A FILM AND ARTICLES THEREFROM” (Bharti et al.), Ser. No. 10/231,570, filed on Aug. 30, 2002, the disclosure of which is incorporated herein by reference.

If the polymer is obtained in pellet form, the pellets may be melt-extruded as a film using procedures well known in the film art. Typically, the thickness of the electret film is in the range of from about 10 to about 2500 micrometers, although thinner and thicker films may also be used. Preferably, the electret film has a thickness in the range of from about 25 to about 310 micrometers, more preferably in the range of from about 50 to about 110 micrometers.

Optionally, one or more additives can be included in the thermoplastic polymer. Exemplary optional additives include antioxidants, light stabilizers (e.g., as available from Ciba Specialty Chemicals, Tarrytown, N.Y. under the trade designations “CHIMASSORB 2020”, “CHIMASSORB 119”, “CHIMASSORB 944”, “TINUVIN 783”, or “TINUVIN C 353”), thermal stabilizers (e.g., as available from Ciba Specialty Chemicals under the trade designations “IRGANOX 1010”, “IRGANOX 1076”), fillers (e.g., inorganic or organic), charge control agents (e.g., as described in U.S. Pat. No. 5,558,809 (Groh et al.)), fluorochemical additives (e.g., as described in U.S. Pat. No. 5,976,208 (Rousseau et al.) and U.S. Pat. No. 6,397,458 (Jones et al.)), glass beads, glass bubbles, colorants (e.g., dyes, pigments (including phosphorescent pigments), and fragrances.

Exemplary optional additives also include titanium dioxide (e.g., in particulate form). If present, the amount of titanium dioxide preferably is in a range of from about 1 to about 50 percent by volume, more preferably in a range of from about 1 to about 20 percent by volume, based on the total volume of the film, although greater and lesser amounts of titanium dioxide particles may also be used.

The electret film may be a unitary film (i.e., a single layer) or it may be multilayered. The electret film may be opaque, transparent, or translucent, and may have distinct regions of differing opacity. The electret film may be perforated.

Preferably, the electret film is free of tackifiers and/or plasticizers.

Electret films can be readily obtained from commercial sources or prepared by a variety of methods that are well known in the art. For details on methods for making electret films, see, for example, “Electrets”, G. M. Sessler (ed.), Springer-Verlag, New York, 1987. Exemplary methods of forming electrets are well known in the art and include thermal electret, electroelectret (e.g., direct current (i.e., DC) corona discharge), radioelectret, magnetoelectret, photoelectret, and mechanical electret forming methods as described in, for example, U.S. Pat. No. 5,558,809 (Groh et al.), the disclosure of which is incorporated herein by reference. Typically, electret films utilized in practice of the present invention have a charge (i.e., electret charge) density of greater than about 0.05 nanocoulombs per square centimeter (nC/cm²), preferably greater than about 0.5 nC/cm², more preferably greater than about 5 nC/cm². DC corona charging (e.g., as described in, for example, U.S. Pat. No. 6,001,299 (Kawabe et al.) and U.S. Pat. No. 4,623,438 (Felton et al.), the disclosures of which are incorporated herein by reference) is a desirable and convenient method for preparing electret films that are useful in practice of the present invention. Exemplary commercially available electret films include polypropylene electret films available under the trade designation “CLINGZ” from Permacharge Corporation, Rio Rancho, N. Mex.

In some embodiments of the present invention, for example, those in which strong bonding is undesirable (e.g., bonding to fragile substrates), it may be preferable that one or more exposed surfaces of the electret article (e.g., the electret film itself or laminate thereof) be free of adhesive or latent adhesive that might accidentally, or by design, strongly adhere to the substrate over time.

The non-tacky crosslinked polymeric layer typically provides a receptive surface for inks, while simultaneously providing erasability. The non-tacky crosslinked polymeric layer may be formed by polymerizing a precursor composition, although other methods (e.g., crosslinking of a polymer or blend thereof using chemical means or ionizing radiation) may also be used. Useful precursor compositions typically comprise one or more polymerizable materials (e.g., monomers and/or oligomers, which may be monofunctional and/or polyfunctional), a curative, and optionally inorganic particles. Polymerizable materials may be, for example, free-radically polymerizable, cationically polymerizable, and/or condensation polymerizable. Useful polymerizable materials include, for example, acrylates and methacrylates, epoxies, polyisocyanates, and trialkoxysilane terminated oligomers and polymers. Preferably, the polymerizable material comprises a free-radically polymerizable material.

Useful free-radically polymerizable materials include, for example, free-radically polymerizable monomers and/or oligomers, either or both of which may be monofunctional or multifunctional. Exemplary free-radically polymerizable monomers include styrene and substituted styrenes (e.g., α-methylstyrene); vinyl esters (e.g., vinyl acetate); vinyl ethers (e.g., butyl vinyl ether); N-vinyl compounds (e.g., N-vinyl-2-pyrrolidone, N-vinylcaprolactam); acrylamide and substituted acrylamides (e.g., N,N-dialkylacrylamides); and acrylates and/or methacrylates (i.e., collectively referred to herein as (meth)acrylates) (e.g., isooctyl (meth)acrylate, nonylphenol ethoxylate (meth)acrylate, isononyl (meth)acrylate, diethylene glycol (meth)acrylate, isobornyl (meth)acrylate, 2-(2-ethoxyethoxy)ethyl (meth)acrylate, 2-ethylhexyl (meth)acrylate, lauryl (meth)acrylate, butanediol mono(meth)acrylate, β-carboxyethyl (meth)acrylate, isobutyl (meth)acrylate, 2-hydroxyethyl (meth)acrylate, (meth)acrylonitrile, isodecyl (meth)acrylate, dodecyl (meth)acrylate, n-butyl (meth)acrylate, methyl (meth)acrylate, hexyl (meth)acrylate, (meth)acrylic acid, stearyl (meth)acrylate, hydroxy functional polycaprolactone ester (meth)acrylate, hydroxyethyl (meth)acrylate, hydroxymethyl (meth)acrylate, hydroxypropyl (meth)acrylate, hydroxyisopropyl (meth)acrylate, hydroxybutyl (meth)acrylate, hydroxyisobutyl (meth)acrylate, tetrahydrofurfuryl (meth)acrylate, ethylene glycol di(meth)acrylate, hexanediol di(meth)acrylate, triethylene glycol di(meth)acrylate, 1,3-propylene glycol di(meth)acrylate, tetraethylene glycol di(meth)acrylate, trimethylolpropane tri(meth)acrylate, 1,4-cyclohexanediol di(meth)acrylate, 1,5-pentanediol di(meth)acrylate, ethoxylated trimethylolpropane tri(meth)acrylate, glycerol tri(meth)acrylate, pentaerythritol tri(meth)acrylate, pentaerythritol tetra(meth)acrylate, dipentaerythritol penta(meth)acrylate, and neopentyl glycol di(meth)acrylate).

Exemplary free-radically polymerizable oligomers include those marketed by UCB Chemicals, Smyrna, Georgia (e.g., under the trade designation “EBECRYL”), and those marketed by Sartomer Company, Exton, Pa. (e.g., under the trade designations “KAYARAD” or “CN”).

For some applications, it may also be useful to include unsaturated fluorinated material such as, for example, one or more fluoroalkyl (meth)acrylates in the polymerizable material. If incorporated in the polymerizable material, the amount of fluorinated material is typically chosen such that dry erase marker inks can effectively wet out the non-tacky crosslinked polymeric layer surface (i.e., the inks do not bead up on the surface).

Depending on the choice of polymerizable material, the precursor composition may, optionally, contain one or more curatives that assist in polymerizing the polymerizable material. The choice of curative for specific polymerizable materials depends on the chemical nature of the copolymerizable material. For example, in the case of epoxy resins, one would typically select a curative known for use with epoxy resins (e.g., dicyandiamide, onium salt, polymercaptan). In the case of free-radically polymerizable resins, free radical thermal initiators and/or photoinitiators are useful curatives.

Typically, the optional curative(s) is used in an amount effective to facilitate polymerization of the monomers and the amount will vary depending upon, for example, the type of curative, the molecular weight of the curative, and the polymerization process. The optional curative(s) is typically included in the precursor composition in an amount in a range of from about 0.01 percent by weight to about 10 percent by weight, based on the total weight of the precursor composition, although higher and lower amounts may also be used. The precursor composition may be cured, for example, by exposure to a thermal source (e.g., heat, infrared radiation), electromagnetic radiation (e.g., ultraviolet and/or visible radiation), and/or particulate radiation (e.g., electron beam).

If the optional curative is a free-radical initiator, the amount of curative is preferably in a range of from about 1 percent by weight to about 5 percent by weight, based on the total weight of the precursor composition, although higher and lower amounts may also be used. Useful free-radical photoinitiators include, for example, benzoin ethers such as benzoin methyl ether and benzoin isopropyl ether, substituted benzoin ethers (e.g., anisoin methyl ether), substituted acetophenones (e.g., 2,2-dimethoxy-2-phenylacetophenone), substituted alpha-ketols (e.g., 2-methyl-2-hydroxypropiophenone), benzophenone derivatives (e.g., benzophenone), and acylphosphine oxides. Exemplary commercially available photoinitiators include photoinitiators available under the trade designation “IRGACURE” (e.g., “IRGACURE 651”, “IRGACURE 184”, “IRGACURE 819”) or “DAROCUR” (e.g., “DAROCUR 1173”, “DAROCUR 4265”) from Ciba Specialty Chemicals, Tarrytown, N.Y., and under the trade designation “LUCIRIN” (e.g., “LUCIRIN TPO”) from BASF, Parsippany, N.J.

Exemplary free-radical thermal initiators include peroxides such as benzoyl peroxide, dibenzoyl peroxide, dilauryl peroxide, cyclohexane peroxide, methyl ethyl ketone peroxide, hydroperoxides, for example, tert-butyl hydroperoxide and cumene hydroperoxide, dicylohexyl peroxydicarbonate, t-butyl perbenzoate, and azo compounds, for example, 2,2,-azo-bis(isobutyronitrile).

The precursor composition may, optionally, include inorganic particles (e.g., dispersed in a mixture of polymerizable material and curative). Exemplary inorganic particles include silica particles, preferably in colloidal form.

Colloidal silicas dispersed as sols in aqueous solutions are available commercially under the trade designations “LUDOX” (E. I. du Pont de Nemours and Company, Wilmington, Del.), “NYACOL” (Nyacol, Ashland, Mass.), and “NALCO” (Nalco Chemical Company, Oak Brook, Ill.). Non-aqueous silica sols (e.g., silica organosols) are also commercially available under such trade names as “NALCO 1057” (a silica sol in 2-propoxyethanol, Nalco Chemical Company), and “MA-ST”, “IP-ST”, and “EG-ST”, (Nissan Chemical Industries, Tokyo, Japan). The silica particles preferably have an average particle diameter in a range of from about 5 nanometers (nm) to about 1000 nm, more preferably in a range of from about 10 nm to about 50 nm. If present, colloidal silica particles are preferably covalently bonded, directly or indirectly, to one or more (meth)acrylate groups.

If utilized, colloidal silica particles typically are present in the polymerizable material in an amount of from about 10 percent by weight to about 50 percent by weight, based on the total weight of colloidal silica particles and polymerizable material, although higher and lower amounts may also be useful. Preferably, colloidal silica particles are present in the polymerizable material in an amount of from about 25 percent by weight to about 40 percent by weight.

Optionally, one or more additives may be mixed with the polymerizable material and optional curative prior to curing. Exemplary useful additives include colorants (e.g., pigments, dyes), fillers, ultraviolet (UV) absorbing agents, antiblocking agents, flame retardant agents, plasticizers, light stabilizers, heat stabilizers, and slip agents.

Further details regarding polymerizable materials, curatives, and inorganic particles may be found in, for example, U.S. Pat. No. 5,258,225 (Katsamberis), U.S. Pat. No. 5,391,210 (Bilkadi et al.), and U.S. Pat. No. 5,677,050 (Bilkadi et al.), the disclosures of which are incorporated herein by reference.

The non-tacky crosslinked polymeric layer may be affixed to a polymeric film by any suitable means known in the art, including, for example, coating a precursor composition (e.g., roll coating, gravure coating, rod coating, spraying, spin coating, dip coating, curtain coating) onto a surface of a polymer film and subsequently polymerizing the precursor composition as described hereinabove.

Typically, the non-tacky crosslinked polymeric layer has a thickness in a range of from about 0.5 micrometers to about 20 micrometers, preferably in a range of from about 2 micrometers to about 14 micrometers, more preferably in a range of from about 3 micrometers to about 8 micrometers, although other thicknesses may be used. Thicker non-tacky crosslinked polymeric layers may cause unacceptable curling of erasable article (e.g., as may result from shrinkage during polymerization of the polymerizable material).

Typically, the non-tacky crosslinked polymeric layer is relatively smooth, although rough non-tacky crosslinked polymeric layers may also be useful. For example, the non-tacky crosslinked polymeric layer may have an average surface roughness Ra (i.e., the average of the absolute distance between the middle value and the actual surface) of less than about 200 nanometers, preferably less than about 150 nanometers, more preferably less than about 100 nanometers. Ra can be readily determined by optical interferometry, for example, using commercially available equipment such that marketed by Veeco Instruments, Woodbury, N.Y., under the trade designation “WYKO HD3300 HEAD MEASUREMENT SYSTEM”.

As hardness tends to increase with crosslink density, useful non-tacky crosslinked polymeric layers may have a scratch hardness (i.e., pencil hardness), according to ASTM D 3363-00 (2000), using a 50 micrometer thick film on a rigid borosilicate glass substrate, of at least about 2H, preferably at least about 4H, more preferably at least about 6H, although lesser values may also be used.

In one embodiment of the invention, the surface of the electret film contacts a substrate. Any solid substrate may be used in practicing the present invention. The substrate may be conductive or nonconductive. Preferably, at least the portion of the surface of the substrate that contacts the electret film is substantially planar. As used herein, the term “substantially planar” encompasses surfaces that are generally planar in appearance, optionally having minor irregularities, imperfections, and/or warpage. Suitable substrates may have vertical and/or horizontal surfaces, and may be painted or unpainted. Exemplary substrates include liners (e.g., papers, thermoplastic polymer films); multilayer optical films (e.g., as described in for example U.S. Pat. No. 5,825,543 (Ouderkirk et al.) and U.S. Pat. No. 5,783,120 (Ouderkirk et al.), the disclosures of which are incorporated by reference), architectural surfaces (e.g., floors, walls, ceilings), glass (e.g., windows, mirrors), metal, drywall, plaster, motor vehicles (e.g., automobiles, trucks, motorcycles), trailers (e.g., truck trailers), mobile homes, boats, furniture (e.g., wicker furniture), boxes, cabinets, mats, wall hangings, doors, dishes (e.g., glasses, plates, and ceramic dishes), ceramic tile, photographs, banners, balloons, signs, paper, and cloth. Preferably, the substrate is non-conductive (i.e., a dielectric), although this is not a requirement.

Typically, erasable articles of the present invention may be removably adhered to a substrate by contacting them the substrate, sliding them to the desired orientation and position, and then smoothing out wrinkles and/or bubbles. After smoothing, the erasable article is preferably rubbed (e.g., with a woven or nonwoven cloth) as described in commonly assigned U.S. patent application entitled “METHOD FOR ELECTROSTATICALLY ADHERING AN ARTICLE TO A SUBSTRATE” (Bharti et al.), U.S. Ser. No. 10/232,259, filed on Aug. 30, 2002, the disclosure of which is incorporated herein by reference. Such rubbing typically serves to increase the level of shear adhesion between the electret film and the substrate.

Erasable articles of the present invention may, optionally, include ink layers and/or printed images such as for example, a continuous ink layer, ornamental designs, and/or indicia (e.g., artistic border, letters, grid lines). Optional ink layers and/or printed images may contain one or more of any known inks (e.g., colored inks, phosphorescent inks, infrared inks). Suitable printing methods and inks are well known and/or commercially available. Exemplary printing methods include flexographic printing, ink jet printing, electrostatic printing, gravure printing, screen printing, and thermal transfer printing. Optional printing may be disposed, for example, on the surface of the non-tacky crosslinked polymeric layer, between the non-tacky crosslinked polymeric layer and the electret film (e.g., as a continuous ink layer), or on an uncoated surface of the electret film.

In one embodiment of the present invention, erasable articles may be combined in kit form with one or more items that would be used in conjunction with erasable articles. Exemplary items include one or more markers (e.g., felt tip markers, dry erase markers), erasers, cloths, and liquid cleaners (e.g., in a spray bottle). While erasable articles of the present invention may be used with markers having any type of ink, preferably they are used with markers containing aqueous inks.

The present invention will be more fully understood with reference to the following non-limiting examples in which all parts, percentages, ratios, and so forth, are by weight unless otherwise indicated.

### EXAMPLES

Unless otherwise noted, all reagents used in the examples were obtained, or are available from, general chemical suppliers such as Aldrich Chemical Co., Milwaukee, Wis., or may be synthesized by known methods.

1,6-Hexanediol diacrylate was obtained under the trade designation “SR 238” from Sartomer Company, Exton, Pennsylvania; pentaerythritol tetraacrylate was obtained under the trade designation “SR 295” from Sartomer Company; and 2-hydroxy-2-methyl-1-phenylpropan-1-one was obtained under the trade designation “DAROCUR 1173” from Ciba Specialty Chemicals, Tarrytown, N.Y.

Preparation of Precursor Composition HC1

Precursor composition HC1 was prepared by combining 10 grams (g) of 1,6-hexanediol diacrylate with 10 g of pentaerythritol tetraacrylate in a dark brown wide-mouth jar. The jar was sealed and then shaken briefly by hand to mix the contents. 2-Hydroxy-2-methyl-1-phenylpropan-1-one (0.4 g) was added to the monomer mixture, and the jar was again briefly shaken to mix the contents. When the mixture appeared to be homogeneous, 20 g of 2-propanol was added to the jar, and the jar was then capped and shaken briefly by hand to thoroughly mix its contents.

Preparation of Precursor Compositions HC2-HC5

Precursor Composition HC2 was obtained under the trade designation “3M 906 ABRASION RESISTANT COATING” as a 50 percent by weight mixture of acrylate monomers and colloidal silica in isopropanol from 3M Company, St. Paul, Minn.

Precursor Compositions HC3, HC4, and HC5 were made by dilution of HC2 with isopropanol as follows: HC3 (60 percent by weight isopropanol), HC4 (70 percent by weight isopropanol), HC5 (80 percent by weight isopropanol).

Preparation of Film A

Zinc polyethylene-methacrylic acid ionomer pellets (78 parts, obtained under the trade designation “SURLYN 1705-1” from E. I. du Pont de Nemours & Company, Wilmington, Del.), and 22 parts of a mixture of 15.4 parts titanium dioxide dispersed in 6.6 parts polyethylene (obtained under the trade designation “STANDRIDGE 11937 WHITE CONCENTRATE” from Standridge Color, Bridgewater, N.J.) were combined and extruded onto a polyester liner (2 mils (50 micrometers) thickness) using a 2.5 inch (6.4 cm) single screw extruder (model number: 2.5TMIII-30, obtained from HPM Corporation, Mount Gilead, Ohio), at a temperature of 199 degrees C., resulting in a film having a thickness of 3 mils (80 micrometers) adhered to a polyester liner (2 mils (50 micrometers) thickness).

Preparation of Film B

Film B was a 3-layer biaxially oriented (7 by 7) film made by simultaneous 3-layer coextrusion. The two outer layers had a thickness of 0.005 mils (0.1 micrometers) and consisted of polypropylene (obtained under the trade designation “FINA-3376” from Atofina Petrochemicals, Houston, Tex.). The central layer consisted of 5 percent by weight titanium dioxide in 95 percent by weight polypropylene (FINA-3376). The total film thickness was 1.85 mils (47 micrometers).

The markers used in the Examples were obtained from commercial sources, and are identified as follows:

Markers A1 and A1′, black and red, respectively, were obtained under the trade designation “MARKS-A-LOT EVERBOLD WHITEBOARD MARKER” from Avery Dennison Corporation, Pasadena, Calif.;

Markers A2 and A2′, black and red, respectively, were obtained under the trade designation “MARKS-A-LOT PERMANENT MARKER” from Avery Dennison Corporation;

Markers B1 and B1′, orange and purple, respectively, were obtained under the trade designation “BOONE SCREAMERS DRY ERASE MARKER” from Boone International Corporation, Corona, California;

Markers B2 and B2′, black and green, respectively, were obtained under the trade designation “BOONE LOW ODOR DRY ERASE MARKER” from Boone International Corporation;

Markers D1 and D1′, black and blue, respectively, were obtained under the trade designation “DIXON DRY ERASE WHITE BOARD MARKER” from Dixon Ticonderoga Company, Heathrow, Fla.;

Markers E1 and E1′, black and blue, respectively, were obtained under the trade designation “LIQUID EXPO DRY ERASE MARKER” from Sanford Corporation, Bellwood, Ill.;

Markers E2 and E2′, black and red, respectively, were obtained under the trade designation “EXPO LOW ODOR DRY ERASE MARKER” from Sanford Corporation;

Markers E3 and E3′, black and green, respectively, were obtained under the trade designation “EXPO DRY ERASE MARKER” from Sanford Corporation; and

Markers S1 and S1′, black and red, respectively, were obtained under the trade designation “SANFORD SHARPIE PERMANENT MARKER” from Sanford Corporation.

Dry Erase Test

The uncoated side of a pair of approximately 8.5 inches by 11 inches (22 cm by 28 cm) samples of each comparative and exemplary film was electrostatically adhered to the surface of 40-point white paperboard obtained under the trade designation “CRESCENT PAPERBOARD” obtained from Unisource Worldwide, Brooklyn Park, Minn., which had larger dimensions than the film being tested. The exposed coated side of each film was cleaned with liquid cleaner obtained under the trade designation “EXPO WHITE BOARD CLEANER” from Sanford Corporation. The cleaned coated surface of each of the two film samples was then marked by writing on it with each of the markers listed above. One of the pair of films was stored for 1 day at a temperature of 23° C. whereas the other of the pair of films was stored for 3 days at a temperature of 49° C.

The marked film samples were evaluated for erasability by rubbing the marked surface of the films with an eraser obtained from Sanford Corporation, Bellwood, Ill., under the trade designation “EXPO ERASER FOR DRY ERASE SURFACES”. The marked films were rubbed by hand with the eraser, using moderate pressure, in a back and forth motion until either the marking was completely erased or until ten back and forth motions had been completed. The film samples were then visually evaluated and rated for erasability according to the following scale, as reported in Table 2: 1=rubbing with the eraser had no effect on the marking; 2=marking was partially removed or was smeared and was still readable; 3=most of the marking was removed, but a faint remnant or “ghost” of the mark was visible; 4=the marking was completely removed.

Wet Erase Test

After the films were evaluated in the dry erase test, the same films were subjected to a wet cleaning test protocol after which they were again evaluated for erasability. Specifically, the films were sprayed with water and were then wiped by hand with a paper towel, using moderate pressure, in ten back and forth motions. The films were then sprayed with a glass cleaner available under the trade designation “WINDEX ORIGINAL GLASS CLEANER” from SC Johnson Company, Racine, Wis., and were again wiped by hand with a paper towel, using moderate pressure, in ten back and forth motions. The films were then sprayed with liquid cleaner obtained under the trade designation “EXPO WHITE BOARD CLEANER” from Sanford Corporation, and were again wiped by hand with a paper towel, using moderate pressure, in ten back and forth motions. The erasability of the films after the sequence of three wet cleaning steps was evaluated as described for the dry erase test and the data are reported in Table 2.

General Method for Preparation of Erasable Films

Erasable films were prepared by coating individual samples of Polymer Films A (after removal of the liner) and B with Precursor Compositions HC1 through HC5, and then curing the precursor composition with electromagnetic radiation. Accordingly, the polymer film was temporarily fastened to a glass plate by taping the corners of the polymer film to the plate with adhesive tape. The hardcoat precursor composition was then coated on the polymer film by means of a #6 Meyer rod (obtained from RD Specialties, Webster, N.Y.) resulting in a nominal wet coating thickness of 15 micrometers. The solvent was then allowed to evaporate at room temperature for approximately one minute. The coated precursor composition was then exposed to high intensity ultraviolet light from a 600 watts/inch (236 watts/cm) microwave driven lamp equipped with a H-type bulb (obtained from Fusion UV Systems, Inc., Gaithersburg, Md.) by passing the coated film under the lamp at a speed of 100 feet per minute (30 m/min, Dosage: UVA 0.166 J/cm², UVB 0.164 J/cm²) under a blanket of nitrogen gas.

The resultant coated and cured films were (with any associated liner removed) were DC corona charged under ambient conditions using a horizontally arranged series of four charging bars (obtained under the trade designation “CHARGEMASTER PINNER ARC RESISTANT CHARGING BAR” from Simco Company, Hatfield, Pa.). The charging bars were spaced as follows: the center to center distance between bar 1 and bar 2 was 3.0 inches (7.6 cm), the center to center distance between bar 2 and bar 3 was 3.25 inches (8.3 cm), and the center to center distance between bar 3 and bar 4 was 3.75 inches (9.5 cm). Each charging bar was situated 1.5 inches (3.5 cm) above a corresponding grounded metal plate. A voltage of +29 kilovolts (relative to the grounded metal plates) was applied to each charging bar. Film samples were charged by placing them on a moving (one foot per minute (1.8 meters per minute)) continuous belt (part number: 8882802A, obtained from Light Weight Belting Corporation, Minneapolis, Minn.) that passed between the charging bars and the metal plates, such that the belt maintained contact with the metal plates. During charging, the coated side of the film faced the belt.

Preparation of Comparative Films

Comparative films were prepared by corona charging individual samples of Polymer Films A and B according to the General Method for Preparation of Erasable Films (above), except that no precursor composition used. Identification of comparative and dry erase films is given in Table 1 (below).

TABLE 1

| FILM | | CROSSLINKED |
|---|---|---|
| IDENTIFICATION | POLYMER FILM | POLYMERIC COATING |
| CA (Comparative) | A | None |
| CB (Comparative) | B | None |
| F1 | A | HC1 |
| F2 | A | HC2 |
| F3 | A | HC3 |
| F4 | A | HC4 |
| F5 | A | HC5 |
| F6 | B | HC2 |
| F7 | B | HC3 |
| F8 | B | HC4 |
| F9 | B | HC5 |

Evaluation of Films for Erasability

The films of Table 1 were evaluated for erasability using the Dry Erase Test and the wet Erase Test. Results are presented in Table 2 (below).

TABLE 2

| | | | DRY | DRY | WET | WET |
|---|---|---|---|---|---|---|
| | | | ERASE | ERASE | ERASE | ERASE |
| | | | RATING | RATING | RATING | RATING |
| | | | AFTER | AFTER | AFTER | AFTER |
| TEST | | | 24 | 72 | 24 | 72 |
| NUM- | | MARK- | HOURS | HOURS | HOURS | HOURS |
| BER | FILM | ERS | AT 23° C. | AT 49° C. | AT 23° C. | AT 49° C. |
| 1 | CA | A1, A1′ | 1 | Not tested | 4 | Not tested |
| 2 | CB | A1, A1′ | 4 | 1 | 4 | 4 |
| 3 | F1 | A1, A1′ | 4 | 1 | 4 | 4 |
| 4 | F2 | A1, A1′ | 4 | 4 | 4 | 4 |
| 5 | F3 | A1, A1′ | 4 | 1 | 4 | 4 |
| 6 | F4 | A1, A1′ | 3 | 1 | 4 | 4 |
| 7 | F5 | A1, A1′ | 3 | 1 | 4 | 4 |
| 8 | F6 | A1, A1′ | 4 | 4 | 4 | 4 |
| 9 | F7 | A1, A1′ | 4 | 4 | 4 | 4 |
| 10 | F8 | A1, A1′ | 4 | 4 | 4 | 4 |
| 11 | F9 | A1, A1′ | 4 | 4 | 4 | 4 |
| 12 | CA | B1, B1′ | 1 | Not tested | 3 | Not tested |
| 13 | CB | B1, B1′ | 4 | 1 | 4 | 4 |
| 14 | F1 | B1, B1′ | 4 | 1 | 4 | 4 |
| 15 | F2 | B1, B1′ | 4 | 3 | 4 | 4 |
| 16 | F3 | B1, B1′ | 4 | 1 | 4 | 4 |
| 17 | F4 | B1, B1′ | 3 | 1 | 4 | 4 |
| 18 | F5 | B1, B1′ | 3 | 1 | 4 | 4 |
| 19 | F6 | B1, B1′ | 4 | 4 | 4 | 4 |
| 20 | F7 | B1, B1′ | 4 | 4 | 4 | 4 |
| 21 | F8 | B1, B1′ | 4 | 4 | 4 | 4 |
| 22 | F9 | B1, B1′ | 4 | 4 | 4 | 4 |
| 23 | CA | B2, B2′ | 1 | Not tested | 3 | Not tested |
| 24 | CB | B2, B2′ | 4 | 2 | 4 | 4 |
| 25 | F1 | B2, B2′ | 4 | 2 | 4 | 4 |
| 26 | F2 | B2, B2′ | 4 | 3 | 4 | 4 |
| 27 | F3 | B2, B2′ | 3 | 2 | 4 | 4 |
| 28 | F4 | B2, B2′ | 3 | 2 | 4 | 4 |
| 29 | F5 | B2, B2′ | 3 | 1 | 4 | 4 |
| 30 | F6 | B2, B2′ | 4 | 4 | 4 | 4 |
| 31 | F7 | B2, B2′ | 4 | 4 | 4 | 4 |
| 32 | F8 | B2, B2′ | 4 | 4 | 4 | 4 |
| 33 | F9 | B2, B2′ | 4 | 4 | 4 | 4 |
| 34 | CA | D1, D1′ | 1 | Not tested | 3 | Not tested |
| 35 | CB | D1, D1′ | 4 | 3 | 4 | 4 |
| 36 | F1 | D1, D1′ | 4 | 1 | 4 | 4 |
| 37 | F2 | D1, D1′ | 4 | 3 | 4 | 4 |
| 38 | F3 | D1, D1′ | 3 | 2 | 4 | 4 |
| 39 | F4 | D1, D1′ | 3 | 2 | 4 | 4 |
| 40 | F5 | D1, D1′ | 3 | 1 | 4 | 4 |
| 41 | F6 | D1, D1′ | 4 | 4 | 4 | 4 |
| 42 | F7 | D1, D1′ | 4 | 4 | 4 | 4 |
| 43 | F8 | D1, D1′ | 4 | 4 | 4 | 4 |
| 44 | F9 | D1, D1′ | 4 | 4 | 4 | 4 |
| 45 | CA | E3, E3′ | 2 | Not tested | 3 | Not tested |
| 46 | CB | E3, E3′ | 4 | 3 | 4 | 3.5 |
| 47 | F1 | E3, E3′ | 4 | 2.5 | 4 | 4 |
| 48 | F2 | E3, E3′ | 4 | 4 | 4 | 4 |
| 49 | F3 | E3, E3′ | 3 | 2 | 3.5 | 4 |
| 50 | F4 | E3, E3′ | 4 | 3 | 4 | 4 |
| 51 | F5 | E3, E3′ | 3 | 2.5 | 4 | 4 |
| 52 | F6 | E3, E3′ | 4 | 4 | 4 | 4 |
| 53 | F7 | E3, E3′ | 4 | 4 | 4 | 4 |
| 54 | F8 | E3, E3′ | 4 | 4 | 4 | 4 |
| 55 | F9 | E3, E3′ | 4 | 4 | 4 | 4 |
| 56 | CA | E2, E2′ | 1 | Not tested | 3 | Not tested |
| 57 | CB | E2, E2′ | 4 | 3 | 4 | 4 |
| 58 | F1 | E2, E2′ | 4 | 3 | 4 | 4 |
| 59 | F2 | E2, E2′ | 4 | 4 | 4 | 4 |
| 60 | F3 | E2, E2′ | 3.5 | 3 | 4 | 4 |
| 61 | F4 | E2, E2′ | 3 | 3 | 4 | 4 |
| 62 | F5 | E2, E2′ | 3 | 2.5 | 4 | 4 |
| 63 | F6 | E2, E2′ | 4 | 4 | 4 | 4 |
| 64 | F7 | E2, E2′ | 4 | 4 | 4 | 4 |
| 65 | F8 | E2, E2′ | 4 | 4 | 4 | 4 |
| 66 | F9 | E2, E2′ | 4 | 4 | 4 | 4 |
| 67 | CA | E1, E1′ | 1 | Not tested | 3.5 | Not tested |
| 68 | CB | E1, E1′ | 4 | 3.5 | 4 | 4 |
| 69 | F1 | E1, E1′ | 4 | 2 | 4 | 4 |
| 70 | F2 | E1, E1′ | 4 | 2.5 | 4 | 4 |
| 71 | F3 | E1, E1′ | 3 | 2.5 | 4 | 4 |
| 72 | F4 | E1, E1′ | 3 | 2.5 | 4 | 4 |
| 73 | F5 | E1, E1′ | 3 | 3 | 4 | 4 |
| 74 | F6 | E1, E1′ | 4 | 3 | 4 | 4 |
| 75 | F7 | E1, E1′ | 4 | 3 | 4 | 4 |
| 76 | F8 | E1, E1′ | 4 | 3 | 4 | 4 |
| 77 | F9 | E1, E1′ | 4 | 3 | 4 | 4 |
| 78 | CA | A2, A2′ | 1 | Not tested | 4 | Not tested |
| 79 | CB | A2, A2′ | 1 | 1 | 4 | 3.5 |
| 80 | F1 | A2, A2′ | 1 | 1 | 4 | 4 |
| 81 | F2 | A2, A2′ | 1 | 1 | 4 | 4 |
| 82 | F3 | A2, A2′ | 1 | 1 | 3.5 | 3.5 |
| 83 | F4 | A2, A2′ | 1 | 1 | 4 | 4 |
| 84 | F5 | A2, A2′ | 1 | 1 | 4 | 4 |
| 85 | F6 | A2, A2′ | 1 | 1 | 4 | 4 |
| 86 | F7 | A2, A2′ | 1 | 1 | 4 | 4 |
| 87 | F8 | A2, A2′ | 1 | 1 | 4 | 4 |
| 88 | F9 | A2, A2′ | 1 | 1 | 4 | 4 |
| 89 | CA | S1, S1′ | 1 | Not tested | 3 | Not tested |
| 90 | CB | S1, S1′ | 1 | 1 | 4 | 3.5 |
| 91 | F1 | S1, S1′ | 1 | 1 | 4 | 4 |
| 92 | F2 | S1, S1′ | 1 | 1 | 4 | 4 |
| 93 | F3 | S1, S1′ | 1 | 1 | 3.5 | 3.5 |
| 94 | F4 | S1, S1′ | 1 | 1 | 4 | 4 |
| 95 | F5 | S1, S1′ | 1 | 1 | 4 | 4 |
| 96 | F6 | S1, S1′ | 1 | 1 | 4 | 4 |
| 97 | F7 | S1, S1′ | 1 | 1 | 4 | 4 |
| 98 | F8 | S1, S1′ | 1 | 1 | 4 | 4 |
| 99 | F9 | S1, S1′ | 1 | 1 | 4 | 4 |

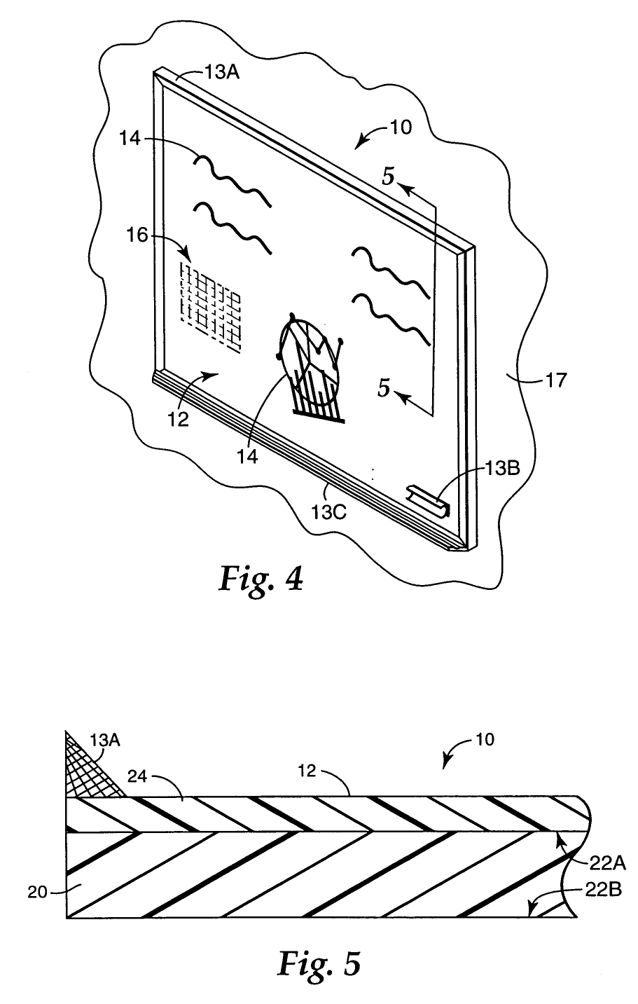

Another embodiment of the invention is illustrated at 10 in FIG. 4. Dry erase article 10 includes writing surface 12 that accepts ink from a writing implement such as a dry erase marker or permanent marker. Dry erase article 10 also may include a frame 13A surrounding the dry erase surface, a clip or holder 13B for a dry erase marker, and a tray 13C. Typically, dry erase markers are used to write on writing surface 12, transferring ink to the writing surface 12 in the form of written indicia 14. In one embodiment, dry erase article 10 may include printed indicia (or “pre-printed” indicia) 16 (shown in dotted lines) which cannot be erased. Examples of printed indicia 16 may include lines, graphics, calendars, and other indicia that may be useful. Dry erase article 10 is illustrated mounted to substantially flat vertical surface 17, such as a wall.

Acceptance of ink on writing surface 12 as written indicia 14 without beading of the ink can be defined as the “wettability” of the dry erase writing surface 12. Acceptable wettability (or writing without dewetting) is accomplished if the surface energy of the writing surface 12 is greater than the surface tension of the solvents in the marker inks. In one embodiment, the surface energy of the writing surface is greater than or equal to about 25 mJ/m². In another embodiment, the surface energy of the writing surface is greater than or equal to about 30 mJ/m², as measured by the Dyne Pen Test described below in the examples. Writing surface 12 additionally provides a level of “erasability” which allows the user to wipe away (e.g. with a dry cloth or dry eraser) written indicia 14 once it is no longer desired. In the current inventive dry erase article 10, writing surface 12 is easily erasable with a simple eraser after heat or time aging of the writing on the dry erase article. In one embodiment, writing surface 12 is erasable with 1 to 2 wipe(s) of a dry eraser after heat aging of up to 54 degrees C. (130 degrees F.) for 2 days or time aging of up to 14 days at room temperature (typically around 22 degrees C. or 72 degrees F.). Easy erasability after aging of the writing is an advantage of the invention over previously known hardcoat compositions used for dry erase.

An additional design characteristic of the inventive dry erase article 10 may be to provide a glossy writing surface 12. In one embodiment, the writing surface has a 60 degree gloss level of 50 gloss units or greater. Increasing the gloss value can typically be accomplished by minimizing the content of large particles or waxes (e.g., 1 μm or greater) that are not polymerized into the coating. In another embodiment, writing surface may have a 60 degree gloss of 75 gloss units or higher.

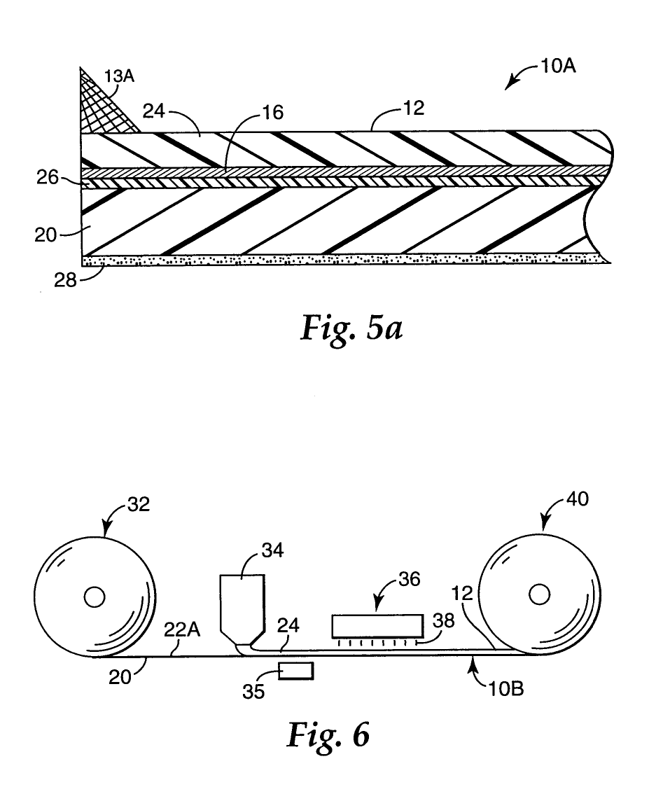

FIG. 5 is a cross-sectional view of dry erase article 10 as taken along lines 2-2. Dry erase article 10 includes substrate 20, having first side 22A and second side 22B. In one embodiment, substrate 20 is has a flexibility of at least 6.4 mm as measured by the Mandrel Bend Test (described below in the examples). Substrate 20, may be clear, translucent or opaque and may be colorless or colored (including white). Hardcoat layer 24 is disposed on first side 22A of substrate 20. In one embodiment, hardcoat layer 24 is UV curable, but may also be cured by other types of radiation (e.g. thermal radiation and electron beam, among others). Cured hardcoat layer 24 forms writing surface 12. In one embodiment, cured hardcoat layer has a hardness of about 500 MPa or greater as measured by the Nanoindenter Hardness Test (described below in the examples), providing the writing surface with a high degree of “erasability”. More preferably, cured hardcoat layer has a hardness of about 600 MPa or greater, and most preferably, cured hardcoat layer has a hardness of about 700 MPa or greater.

As discussed above with respect to FIG. 4, it is desirable for writing surface 12 to have a surface energy of greater than about 25 mJ/m². This surface energy of hardcoat layer 24 prevents ink from typical dry erase and permanent markers from beading up on the writing surface 12. In the current embodiment, the combination of “wettability” and “erasability” provide a high performance dry erase article. Written indicia 14 is received as a continuous layer, preventing beading up or “gaps” in the lines forming written indicia 14. Additionally, written indicia 14 can be quickly removed from dry erase article 10 with a minimum of wiping and a minimum of absorbance of ink (or “ghosting”) by dry erase article 10.

It should be noted that various embodiments of the inventive dry erase article 10A may also include optional additional coating layers, as illustrated in FIG. 5A. For example, primer layer 26 may be used to facilitate adhesion of hardcoat layer 24 to substrate 20. Additionally, pre-printed indicia 16 may also be included, either in a layer between substrate 20 and hardcoat layer 24 (as shown), or on the opposite side of substrate 20 (e.g. more proximate second side 22B of substrate 20) if substrate 20 is transparent or translucent.

An optional adhesive layer 28 may also be included in dry erase article 10A, providing the user the ability to secure dry erase article 10A to a wall, desktop, or other surface without mechanical fasteners (or when the substrate does not have cling properties). Adhesive layer 28 can be any type of adhesive desirable for the end use application. For example, permanent, repositionable and positionable adhesives may be used. The adhesives may be pressure-sensitive, hot melt, or thermally activated. If the adhesive chosen is pressure-sensitive, it may be desirable to include a release liner (as known in the art) disposed against the pressure-sensitive adhesive as part of dry erase article 10A. Adhesive layer 28 may be coated directly on second side 22B of substrate, or may include other optional layers between substrate 20 and adhesive layer 28. Other layers, coatings and treatments may be included in dry erase article 10A as would be known to one skilled in the art.

The substrate 20 may further be secured (e.g. by mechanical fasteners or adhesive layer, among other methods known in the art) to a more rigid board (e.g. cardboard or particleboard) or another flexible sheet forming a dry erase article that may be placed or secured on a final user surface (e.g. a wall or a desk). Alternately, (as described previously in great detail) dry erase article may have cling properties that allow it to be secured to a surface. In another embodiment, the dry erase article may be attached to a mechanical fastener backing (such as the hook portion of a hook and loop fastener) for mounting to a cloth wall or mating with another mechanical fastener. The dry erase article can be secured using any number of securing methods known in the art such as using adhesives or mechanical fasteners, among others.

FIG. 6 is a schematic drawing illustrating one exemplary method of manufacturing the inventive dry erase article 10. Flexible substrate 20 is unwound from unwind roll 32. This forms a moving “web” which is translated under coating station 34. Coating station 34 coats hardcoat layer 24 onto first side 22A of substrate 20. Coating station 34 can utilize any number of coating methods known to the art such as gravure coating, die coating, roll coating, rod coating, offset printing, and flexographic printing. The hardcoat layer 24 and substrate 20 proceed through optional drying station 35 to remove any solvent from hardcoat layer 24. Drying station 35 typically uses heat to evaporate the solvent. Substrate 20 and hardcoat layer 24 are translated under a curing station 36. In one embodiment, curing station 36 is an ultra-violet (UV) radiation source, which emits UV radiation 38 onto hardcoat layer 24 to cure the hardcoat layer 24. Other types of radiation (e.g. electron beam or thermal radiation) may be used to cure hardcoat layer 24, as known in the art.

Substrate 20 and hardcoat layer 24, now secured together, form dry erase article 10B and proceed to takeup roll 40. The process illustrated in FIG. 6 is one example of a continuous manufacturing process enabled by the current inventive dry erase article 10B. Since the substrate is flexible, it can be easily transported and unwound from rolls (such as unwind roll 32). Additionally, the cured hardcoat layer 24 does not substantially affect the flexibility of the substrate, allowing dry erase article 10B to be continuously fed to later stages of manufacture (such as take up roll 40). Other continuous manufacturing processes can be performed on the moving web of material, such as coating or affixing optional layers (discussed previously), or cutting, slitting and stacking of the web. The order of the process may be altered as well. However, in any continuous manufacturing process enabled by the current inventive dry erase article 10A, the combined flexibility of the substrate and hardcoat layer 24 increases throughput over “batch” type manufacturing required by the inflexible substrate and/or hardcoats of many previous styles of dry erase articles (e.g. cured melamine resins and porcelain covered steel).

As discussed, one embodiment of the invention comprises coating of the radiation curable hardcoat coating composition on a flexible substrate in a continuous coating and curing process. A flexible substrate is one that can be wound about itself into a roll without cracking either the substrate or the coating applied to the substrate. The flexible substrate can be unwound, and successively passed through a coating station, a drying station, and a curing station, and wound into roll at the end of the process. The hardcoat coating of the invention does not substantially affect the ability of the substrate to be wound into a roll. An advantage of this coating process is that many yards of the material may be made continuously without stopping. This results in low manufacturing cost. Flexibility of a film or a coated film can be measured by the Mandrel Bend Test described in more detail in the example section. A flexible substrate can be bent 180 degrees around a 6.4 mm diameter mandrel without showing any visible signs of cracking or fracture. A flexible substrate coated with the cured hardcoat layer of the present invention can also be bent 180 degrees around a 6.4 mm diameter mandrel without any visible signs of cracking, fracture, or debonding. More preferably, the flexible coated substrate can be bent 180 degrees around a 3.2 mm mandrel without any change an appearance. This flexibility additionally increases ease of use of inventive dry erase article 10, since the article can be rolled or otherwise applied without harm to the dry erase article 10. In fact, the dry erase article itself can act as a living hinge in a dry erase article wherein the bend radius of the living hinge does not exceed the bend resistance of the coated substrate.

Another embodiment of the invention comprises coating of the radiation curable hardcoat coating composition on a rigid or flexible substrate in a sheet fed process. An example of a sheet fed process is a sheet fed printing press. A stack of rigid or flexible sheets is placed at one end of a printing press. Graphics can be printed on the substrate with several printing methods including flexo printing and offset printing. Then the radiation curable coating composition can be applied to the sheet by one of several printing methods including flexographic printing. The sheet is then fed through a radiation curing station.

While the inventive dry erase article allows for a high degree of flexibility, facilitating manufacturing and ease of use, cured hardcoat layer 24 also has a hardness of at least about 500 MPa, and a surface energy of greater than about 25 mJ/m² providing inventive dry erase article with a high degree of wettability and erasability. This combination of flexibility, wettability and erasability is advantageous over previously known dry erase articles.

Substrates

As previously discussed, and shown, curable hardcoat layer 24 is coated onto substrate 20. Suitable substrates for the inventive dry erase article are sheets and films of polymeric resins, including both thermoplastic and thermoset resins. Example polymeric resins are polyesters, polyethers, polyamides, polyurethanes, polyacrylates, polyolefins, polyvinyls, cellulose esters, epoxy resins, phenolic resins, polysiloxanes, polystyrene, copolymers of acrylonitrile-styrene, butyrates, and the like. Other suitable substrates are based on paper, for example, uncoated paper, coated paper, polymer coated paper, and paper film laminates. Metal films and sheets are also suitable substrates. In one embodiment, the substrate is chosen so as to have a flexibility of at least about 6.4 mm as measured by the Mandrel Bend Test allowing the substrate to be used in a continuous (or web type) manufacturing process, and/or allows it to be easily manipulated by the end user. Although not necessary in all cases due to the adherence of coating compositions used in the current invention, separate primer layer(s) 26 (as discussed above), comprising a single ingredient or mixture of ingredients, may be used to improve the bond of the coating to the substrate. Example primers include polyacrylates, melamine acrylates, poly vinyl chlorides, poly vinylidene chlorides, and polyvinyl alcohols. Texturizing, chemical, or physical treatment of the surface may also be used to improve bonding, for example, corona treatment.

Hardcoat Layer

As previously shown and described, substrate 20 is coated on a first surface with a cured coating layer 24 (also may be referred to as a “hardcoat coating solution”, “hardcoat composition” or “dry erase coating”).

The hardness of the hardcoat layer can be measured by Taber abrasion (known in the art) followed by a haze measurement. More abrasion resistant films typically have less haze after abrasion by the Taber wheel. However, Taber abrasion of a film can also be reduced by the presence of a lubricant on the film. Example lubricants include hydrocarbons, fluorocarbons, and silicones, whether polymerized into the hardcoat coating solution or merely present at the surface. A more direct instrument for measuring hardness is a nanoindenter. The Nanoindenter Hardness Test is discussed further in the example section.

As discussed previously, it is desirable to create a dry erase article that erases easily with a simple dry eraser even after the dry erase writing has been present on the surface for a long time. The current invention has found an unexpected correlation between the hardness of the cured hardcoat and the ability to erase dry erase markers after time and/or heat aging of written indicia on the writing surface. That is, harder UV curable acrylic coatings were easier to erase than softer UV curable acrylic coatings. Increased hardness was made possible by addition of colloidal inorganic oxide particles, preferably silica particles, and more preferably silica particles reacted with a silane coupling agent.

It is also desirable to provide a writing surface that accepts ink from permanent and dry erase markers without dewetting or beading up of ink. Typical marker solvents include ethanol, isopropanol, methyl isobutyl ketone, n-butyl acetate, ethyl acetate, n-propanol, and n-butanol. In order for the marker to completely wet out the dry erase surface without beading up, the surface energy of the dry erase surface must be greater than the surface tension of the solvents in the maker. The solvent in the list above with the highest surface tension is n-butyl acetate, with a surface tension of about 25 mJ/m². Therefore, in one embodiment, the writing surface of the dry erase article has a surface energy greater than about 25 mJ/m². In an alternate embodiment, the writing surface of the dry erase article has a surface energy greater than about 30 mJ/m² as measured by the Dyne Pen Test.

Hardcoat Coating Solution

Hardcoat coating compositions that may be suitable for use with the current inventive dry erase article are disclosed in U.S. Pat. No. 4,885,332, U.S. Pat. No. 5,104,929, U.S. Pat. No. 6,458,462 and U.S. Pat. No. 6,265,061, all of which are incorporated by reference in their entirety herein.

In one embodiment, the hardcoat coating solution comprises an organic matrix and colloidal inorganic oxide particles. The organic matrix can include a variety of monomers, oligomers, and/or polymers that form the cured matrix for the inorganic oxide particles. The organic matrix comprises at least one ethylenically unsaturated monomer. Preferably, the organic matrix contains at least one organofunctional silane monomer coupling agent. Optional initiators, photosensitizers and additives may also further comprise the curable composition from which the cured organic matrix of the cured hardcoat composition is derived, which are discussed in more detail below. The radiation curable hardcoat coating composition also includes inorganic oxide particles, which are discussed in more detail below.

Within the present invention, it is possible to make a coatable UV hardcoat solution at 100% solids or, by adding a solvent, reduce the solids below 100%. The 100% solids hardcoat solution has economic and environmental advantages. Solvents also offer advantages. Solvents reduce the viscosity of hardcoat solutions to make them more coatable by some coating methods.

A radiation curable hardcoat composition of the present invention preferably includes an organic matrix and colloidal inorganic particles that preferably include silica. Preferably, the cured organic matrix is prepared from a curable organic binder, or curable composition, that includes an ethylenically unsaturated monomer selected from the group of at least one multifunctional ethylenically unsaturated ester of (meth)acrylic acid, at least one monofunctional or difunctional ethylenically unsaturated monomer and combinations thereof, and at least one organofunctional silane coupling agent.

The curable hardcoat composition preferably includes no greater than about 80 percent by weight (wt. %) of at least one ethylenically unsaturated monomer and at least about 20 wt. % colloidal inorganic oxide particles, based on the total weight of the hardcoat composition without solvent. Weight percent composition of the hardcoat solution from this point on will represent the solids portion of the composition, (e.g., without added solvent). Preferably, it includes at least about 40 wt. % of at least one ethylenically unsaturated monomer, and no greater than about 60 wt. % of colloidal inorganic oxide particles.

If the ethylenically unsaturated monomers used include a mixture of multifunctional and monofunctional ethylenically unsaturated monomers, the multifunctional monomer including any difunctional monomer is preferably used in an amount of at least about 20 wt. %, and the monofunctional monomer is preferably used in an amount of at least about 5 wt. %. Preferably, the multifunctional monomer including any difunctional monomer is used in an amount of no greater than about 60 wt. %, and the monofunctional monomer is used in an amount of no greater than about 20 wt. %. If used, an organofunctional silane coupling agent is preferably used in an amount of at least about 5 wt. %, more preferably, at least about 10 wt. % based on the weight of the coating composition without solvent.

The combination of the organic matrix with the colloidal inorganic oxide particles results in unexpected and improved properties as an easily erasable hardcoat coating for dry erase articles. The multifunctional ethylenically unsaturated esters of (meth)-acrylic acid tend to increase the hardness of the coating, whereas the monofunctional or difunctional ethylenically unsaturated monomer tends to “toughen” the coating without significant loss in abrasion resistance.

Ethylenically Unsaturated Monomer

In one embodiment, the organic matrix comprises at least one ethylenically unsaturated monomer and preferably, at least one coupling agent. The ethylenically unsaturated monomer(s) of the organic matrix may be at least one multifunctional ethylenically unsaturated monomer, or a combination of at least one multifunctional ethylenically unsaturated monomer and at least one monofunctional or difunctional ethylenically unsaturated monomer.

The multifunctional ethylenically unsaturated monomer may be an ester of (meth)acrylic acid. It is more preferably selected from a group consisting of a trifunctional ethylenically unsaturated ester of acrylic or methacrylic acid, a tetrafunctional ethylenically unsaturated ester of acrylic or methacrylic acid, and combinations thereof. Of these, trifunctional and tetrafunctional ethylenically unsaturated esters of (meth)acrylic acid are more preferred. Examples of suitable multifunctional ethylenically unsaturated esters of (meth)acrylic acid are the polyacrylic acid or polymethacrylic acid esters of polyhydric alcohols including, for example, the triacrylic acid and trimethacrylic acid esters of aliphatic triols such as glycerin, 1,2,3-propanetrimethanol, 1,2,4-butanetriol, 1,2,5-pentanetriol, 1,3,6,-hexanetriol, and 1,5,10-decanetriol; the tetraacrylic and tetramethacrylic acid esters of aliphatic triols, such as 1,2,3,4-butanetetraol, 1,1,2,2-tetramethylolethane, 1,1,3,3-tetramethylolpropane, and pentaerythritol; the pentaacrylic acid and pentamethacrylic acid esters of aliphatic pentol such as adonitol; the hexaacrylic acid and hexamethacrylic acid esters of hexanols such as sorbitol and dipentaerythritol; the diacrylic acid and dimethacrylic acid esters of aromatic diols such as resorcinol, pyrocatecol, bisphenol A, and bis(2-hydroxyethyl) phthalate; the trimethacrylic acid ester of aromatic triols such as pyrogallol and 2-phenyl-2,2-methylolethanol; and the hexaacrylic acid and hexamethacrylic acid esters of dihydroxy ethyl hydantoin; and mixtures thereof.

Preferably, the multifunctional ethylenically unsaturated ester of (meth)acrylic acid is selected from the group consisting of pentaerythritol triacrylate, pentaerythritol trimethacrylate, pentaerythritol tetraacryalte and a combination thereof.

In addition to the multifunctional ethylenically unsaturated esters of acrylic acid, the curable composition, from which the cured organic matrix is derived, may include at least one difunctional ethylenically unsaturated monomer. The difunctional ethylenically unsaturated monomer may be a difunctional ethylenically unsaturated ester of (meth)acrylic acid (that is, an alkyl and/or aryl acrylate or methacrylate).

The difunctional ethylenically unsaturated monomer is preferably selected from a group consisting of a difunctional ethylenically unsaturated esters of acrylic or methacrylic acid. Examples of suitable difunctional ethylenically unsaturated esters of (meth)acrylic acid are the polyacrylic acid or polymethacrylic acid esters of polyhydric alcohols including, for example, the diacrylic acid and dimethylacrylic acid ester of aliphatic diols such as ethyleneglycol, triethyleneglycol, 2,2-dimethyl-1,3-propanediol, 1,3-cyclopentanediol, 1-ethoxy-2,3-propanediol, 2-methyl-2,4-pentanediol, 1,4-cyclohexanediol, 1,6-hexamethylenediol, 1,2-cyclohexanediol, and 1,6-cyclohexanedimethanol. Preferably the difunctional ethylenically unsaturated monomer is 1,6-hexanediol diacrylate.

In addition to the multifunctional ethylenically unsaturated esters of acrylic acid, the curable composition, from which the cured organic matrix is derived, may include at least one monofunctional ethylenically unsaturated monomer. The monofunctional ethylenically unsaturated monomer may be selected from a group consisting of a monofunctional (meth)acrylic acid ester, a (meth)acrylamide, an alpha-olefin, a vinyl ether, a vinyl ester, a vinyl amide and combinations thereof. Example monofunctional ethylenically unsaturated esters of (meth)acrylic acid include, but are not limited to, 2-hydroxyethyl acrylate, 2-hydroxymethylacrylate, 2-methylbutyl acrylate, isooctyl acrylate, lauryl acrylate, 4-methyl-2-pentyl acrylate, isoamyl acrylate, sec-butyl acrylate, n-butyl acrylate, n-hexyl acrylate, 2-ethylhexyl acrylate, n-octyl acrylate, n-decyl acrylate, isodecyl acrylate, isodecyl methacrylate, and isononyl acrylate.

The monofunctional acrylate monomer may be an N,N-disubstituted (meth) acrylamide monomer or an N-substituted-N-vinyl-amide. Examples of suitable (meth)acrylamides are N-tert-butylacrylamide, N,N-dimethylacrylamide, N,N-diethylacrylamide, N-(5,5-dimethylhexyl) acrylamide, N-(hydroxymethyl) acrylamide, N-(isobutoxymethyl)acrylamide, N-isopropylacrylamide, N-methylacrylamide, N-ethylacrylamide, N-methyl-M-ethylacrylamide, N-(fluoren-2-yl)acrylamide, N-(2-fluorenyl)-2-methylacrylamide, 2,3-bis(2-furyl)acrylamide, N,N′-methylene-bis acrylamide. One preferred acrylamide is N,N-dimethyl acrylamide. N-vinyl caprolactam is an example of an N-vinyl-amide.

Inorganic Oxide Particles

In the present embodiment, the radiation curable hardcoat composition preferably includes colloidal inorganic oxide particles. The inorganic oxide particles are dispersed within the cured organic matrix. One preferred inorganic oxide particle is silica, however others may be used.

It is desirable that the colloidal inorganic particles of the coating be derived from a sol rather than a powder, which can result in an intractable mass that is unsuitable for coating. The addition of additives, such as high molecular weight polymers, may enable compositions derived from colloidal powder to be cast onto inorganic polymeric substrates. The colloidal silica particles are employed in the coating at 10% to 50% by weight, and more preferably, at 25% to 40% by weight.

Silica sols useful for preparing hardcoat compositions can be prepared by methods well known in the art. As used herein, “sol” shall refer to a colloidal dispersion of substantially non-aggregated, inorganic oxide particles in a liquid medium. Colloidal silicas dispersed as sols in aqueous solutions are also available commercially under such trade names as LUDOX (E.I. DuPont de Nemours and Co., Wilmington, Del.), NYACOL (Nyacol Co., Ashland, Mass.), and NALCO 2327 and 1042 (Nalco Chemical Co., Oak Brook, Ill.). Nonaqueous silica sols (also called silica organosols) are also commercially available under the trade names NALCO 1057 (a silica sol in 2-propoxyethanol, Nalco Chemical Co.), MA-ST, IP-ST, and EG-ST (Nissan Chemical Ind., Tokyo, Japan) and HIGHLINK OG Silica Organosols (Clariant Corporation, Charlotte, N.C.). In one embodiment, the silica particles preferably have an average particle diameter of about 5 nm to about 1000 nm, and preferably have an average particle diameter of about 10 nm to about 50 nm. Average particle size can be measured using transmission electron microscopy or light scattering techniques to count the number of particles of a given diameter. Additional examples of suitable colloidal silicas are described in U.S. Pat. No. 5,126,394 (Bilkadi).

Preferably, the silica particles are functionalized with a coupling agent. More preferably, the silica particles are (meth)acrylate functionalized. Herein “(meth)acrylate functionalized” means the silica particles are functionalized with a (meth)acrylate terminated organofunctional silane. The functionalized particles bond intimately and isotropically with the organic matrix. Typically, the silica particles are functionalized by adding a (meth)acrylate functionalized silane to aqueous colloidal silica. Examples of (meth)acrylate functionalized colloidal silica are described in U.S. Pat. No. 4,491,508 (Olsen et al.), U.S. Pat. No. 4,455,205 (Olsen et al.), U.S. Pat. No. 4,478,876 (Chung), U.S. Pat. No. 4,486,504 (Chung), and U.S. Pat. No. 5,258,225 (Katsamberis).

In addition to silica, or in place of silica, the colloidal inorganic particles may be colloidal articles of higher refractive index than silica. Examples of such higher index colloidal particles include, but are not limited to, alumina, titania, zirconia, ceria, and antimony oxide sols, all of which are available commercially from suppliers such as Nyacol Co., Ashland, Mass., and Nalco Chemical Co., Oak Brook, Ill.

Organofunctional Silane Monomer Coupling Agent

In one embodiment, the curable organic matrix composition with colloidal inorganic oxide particles contains an organofunctional silane monomer coupling agent. A wide variety of organofunctional silane monomers may be used in the practice of the present invention. Some preferred organofunctional silanes are hydrolyzable organofunctional silanes, also known in the art as “coupling agents” for coupling silica particles to organic materials. Representative examples include methyl trimethoxysilane, methyl triethoxysilane, phenyl trimethoxysilane, phenyl triethoxysilane, (meth)acryloxyalkyl trimethoxysilanes, such as methacryloxypropyl trimethoxysilane, (meth)acryloxypropyl trichlorosilane, phenyl trichlorosilane, vinyl trimethoxysilane, vinyl triethoxysilane, propyl trimethoxysilane, propyl triethoxysilane, glycidoxypropyl trimethoxysilane, glycidoxypropyl triethoxysilane, glycidoxypropyl trichlorosilane, perfluoroalkyl trimethoxysilane, perfluoroalkyl triethoxysilane, perfluoromethylalkyl trimethoxysilanes, such as tridecafluoro-1,1,2,2-tetrahydrooctyl trimethoxysilane, perfluoroalkyl trichlorosilanes, trifluoromethylpropyl trimethoxysilane, trifluoromethylpropyl trichlorosilane, and perfluorinated sulfonimido ethyl trimethoxysilane (available from the 3M Company, St. Paul, Minn., under the trade designation FC 405), combinations of these, and the like. Most preferably, the organofunctional silane monomer is (meth)acryloxypropyl trimethoxysilane.

Optional Initiators and Photosensitizers

During the manufacture of inventive dry erase article, the uncured hardcoat coating composition can be exposed to an energy source, for example, heat, ultraviolet (UV) radiation or electron beam (e-beam) radiation, which initiates a curing process of the curable composition. This curing process typically occurs via a free radical mechanism, which can require the use of a free radical initiator (simply referred to herein as an initiator, for example, a photoinitiator or a thermal initiator). If the energy source is an electron beam, the electron beam generates free radicals and no initiator is required. When the initiator is exposed to one of these energy sources, the initiator generates free radicals, which then initiates the polymerization and cross-linking.

Examples of suitable free radical thermal initiators include, but are not limited to, peroxides such as benzoyl peroxide, azo compounds, benzophenones, and quinones. Examples of photoinitiators that generate a free radical source when exposed to visible light radiation include, but are not limited to, benzophenones. Examples of photoinitiators that generate a free radical source when exposed to ultraviolet light include, but are not limited to, organic peroxides, azo compounds, quinines, benzophenones, nitroso compounds, hydrozones, pyrylium compounds, triacrylimidazoles, benzoin, benzoin ethers, and methylbenzoin, Examples of commercially available ultraviolet photoinitiators include those available under the trade designations Irgacure 184 (1-hydroxycyclohexyl phenyl ketone), Irgacure 361 and Darocur 1173 (2-hydroxy-2-methyl-1-phenyl-propan-1-one) from Ciba Specialty Chemicals, Tarrytown N.Y. Typically, if used, an amount of an initiator is included in the precursor composition to effect the desired level and rate of cure. Preferably, the initiator is used in an amount of about 0.1 wt. % to about 10 wt. %, and more preferably about 1 wt. % to about 3 wt. %, based on the total weight of the curable composition without solvent. It should be understood that combinations of different initiators can be used if desired.

In addition to the initiator, the curable hardcoat composition of the present invention can include a photosensitizer. The photosensitizer aids in the formation of free radicals that initiate curing of the precursor composition, especially in an air atmosphere. Suitable photosensitizers include, but are not limited to, aromatic ketones and tertiary amines. Suitable aromatic ketones include, but are not limited to, benzophenone, acetophenone, benzil, benzaldehyde, and o-chlorobenzaldehyde, xanthone, tioxanthone, 9,10-anthraquinone, and many other aromatic ketones. Suitable tertiary amines include, but are not limited to, methyldiethanolamine, ethyldiethanolamine, triethanolamine, phenylmethyl-ethanolamine, dimethylaminoethylbenzoate, and the like. Typically, if used, an amount of initiator is included in the precursor compositions to effect the desired level and rate of cure. Preferably, the amount of photosensitizer used in the compositions of the present invention is about 0.01 wt. % to about 10 wt. %, more preferably about 0.05 wt. % to about 5 wt. %, and most preferably, about 0.25 wt. % to about 3 wt. %, based on the total weight of the coating composition (that is, the dry erase coating composition without solvent). It should be understood that combinations of different photosensitizers can be used if desired.

Methods of curing include heat, UV and e-beam. However, other methods may be used. If thermal (or heat) curing is used, however, the temperature must not be so high that it will melt the dry erase article or substrate.

Solvent

In addition to the other components of the radiation curable hardcoat composition, it may further include a solvent or solvents. The curable hardcoat coating composition may include a solvent or solvents to reduce the viscosity of the curable coating composition in order to enhance the coating characteristics. The appropriate viscosity level depends upon various factors such as the coating thickness, application technique, and the type of substrate material onto which the hardcoat coating composition is applied.

The organic solvent(s) should be selected such that they are compatible with the components in the hardcoat coating composition. As used in this context, “compatible” means that there is minimal phase separation between the solvent and the curable organic binder or matrix of the hardcoat coating composition. Additionally, the solvent or solvents should be selected such that they do not adversely affect the cured hardcoat coating properties. Furthermore, the solvent(s) should be selected such that they have an appropriate drying rate. That is, the solvent(s) should not dry too slowly, which would slow down the process of making a coated dry erase article, nor too quickly, which could cause defects such as pin holes or craters in the hardcoat coating. Examples of suitable solvents include alcohols, preferably the lower alcohols such as isopropyl alcohol, n-butanol, methanol, ethanol, and ketones such as methyl ethyl ketone, glycols, heptane, and combinations thereof.

Additives

The hardcoat coating composition can also include a leveling agent to improve the flow or wetting of the curable hardcoat coating composition on the substrate (before it is cured). The leveling agent can be a solvent that is used to adjust the viscosity of the hardcoat coating composition. If the hardcoat coating composition does not properly wet the substrate, this can lead to visual imperfections such as pinholes and/or ridges in the coating. Examples of leveling agents include, but are not limited to, fluorochemical surfactants and alkoxy terminated polysilicones. An example of a fluorochemical surfactant is FC-4430 available from 3M Company, St. Paul, Minn. The hardcoat coating composition can include an amount of a leveling agent to impart the desired result. Preferably, the leveling agent is present in an amount up to about 1 wt. %, and more preferably, about 0.1 wt. % to about 0.5 wt. %, based on the total weight of the hardcoat coating composition. It should be understood that combinations of different leveling agents can be used if desired.

Polymeric materials are known to degrade by a variety of mechanisms. Common additives that can offset this are known as stabilizers, absorbers, antioxidants, and the like. The hardcoat coating compositions of the present invention can include one or more of the following: ultraviolet stabilizer, ultraviolet absorber, ozone stabilizer, and thermal stabilizer/antioxidant.

An ultraviolet stabilizer and/or ultraviolet absorber for improving weatherability and reducing the yellowing of the hardcoat coating with time. An example of an ultraviolet stabilizer includes that available under the trade designation Tinuvin 292 (bis(1,2,2,6,6-pentamethyl-4-piperidinyl)sebacate) and an example of an ultraviolet absorber includes that available under the trade designation Tinuvin 1130 (hydroxyphenyl benzotriazole), both of which are available from Ciba Specialty Chemicals, Tarrytown, N.Y. The hardcoat coating composition can include an amount of either an ultraviolet stabilizer and/or an ultraviolet absorber to impart the desired result. Preferably, the ultraviolet stabilizer or absorber is present in an amount up to about 10 wt. %, and more preferably, about 1 wt. % to about 5 wt. %. based on the total weight of the hardcoat coating composition. It should be understood that combinations of different ultraviolet stabilizers and absorbers can be used if desired.

An ozone stabilizer protects against degradation resulting from reaction with ozone. Examples of ozone stabilizers include, but are not limited to, hindered amines such as that available under the trade designation Irganox 1010 available from Ciba Specialty Chemicals and phenoltriazine commercially available from Aldrich Chemical Company, Inc., Milwaukee, Wis. The hardcoat coating composition can include an amount of an ozone stabilizer to impart the desired result. Preferably, the ozone stabilizer is present in an amount up to about 1 wt. %, more preferably about 0.1 wt. % to about 1.0 wt. %, and most preferably about 0.3 wt. % to about 0.5 wt. %, based on the total weight of the hardcoat coating composition.

A thermal stabilizer/antioxidant reduces the amount of yellowing as a result of weathering. Examples of such materials include, but are not limited to, low melting hindered phenols and triesters. Specific examples include 2,6-di-tert-butyl-4-methylphenol commercially available under the trade designation ULTRANOX 226 antioxidant from Borg Warner Chemicals, Inc., Parkersburg, N.Y.; octadecyl 3,5-di-tert-butyl-4-hydroxycinnamate commercially available under the trade designations ISONOX 132 antioxidant (Schnectady Chemicals, Inc., Schnectady, N.Y.) or VANOX 1320 antioxidant (Vanderbilt Co., Inc. Norwalk, CN). The hardcoat coating composition can include sufficient thermal stabilizer/antioxidant to impart the desired result. Preferably, the thermal stabilizer/antioxidant is present in an amount up to about 3% by weight, and more preferably about 0.5 to about 1%, based on the total weight of the hardcoat coating composition without solvent. It should be understood that combinations of different thermal stabilizers/antioxidants can be used if desired.

Other optional additives to the curable hardcoat coating composition, that eventually forms the cured organic matrix after curing, are waxes and thermosetting resins. The thermosetting resins may be used to impart their specific properties to the hardcoat coating composition of the present invention. Such properties may be desired for particular dry erase articles or portions of dry erase articles. Some examples of such resins include acrylic, acryl-melamine, acryl-epoxy, acryl-urethane, melamine-alkyd, epoxy, epoxy-phenolic, or phenolic resins. These resins are easy to obtain commercially. Waxes are organic particles that are not polymerized into the cured coating and therefore may reduce the hardness of the coating.

It should be understood that any additive to the coating composition not polymerized into the coating may reduce the crosslink density and the hardness of the cured coating. Therefore in one embodiment of the invention, the use of additives is minimized. Reduced hardness may cause the dry erase article to be harder to erase. Therefore, all additives preferably are used at the minimum possible concentration level to achieve the desired stabilization of the coating. Additives preferably make up less than 10 wt. % of the cured hardcoat composition.

Primer and Adhesive Layers

The first surface of the substrate may be chemically or physically treated to promote adhesion of the curable hardcoat coating composition to the first surface of the substrate. Chemical treatments include polyacrylates, melamine acrylates, poly vinyl chlorides, poly vinylidene chlorides, and polyvinyl alcohols. Physical treatments include texturizing, corona treatment and flame treatment.

The second surface of the substrate may be chemically or physically treated to promote adhesion of an optional adhesive to it. Suitable adhesives include permanent pressure sensitive adhesives, repositionable adhesives, and hot melt adhesives. The adhesives allow attachment of the dry erase article to a more rigid surface to make a dry erase board. The adhesive may also allow the attachment of the dry erase substrate directly to some surface such as a wall, door, filing cabinet, or the like.

The radiation curable hardcoat coating composition can be coated by a number of available coating methods known in the art, including but not limited to gravure coating, die coating, roll coating, rod coating and printing methods, including but not limited to offset and flexographic printing.

The present invention will be more fully understood with reference to the following non-limiting examples.

### EXAMPLES

Preparation of Article

Flexible coated substrates were cut into sheets about 22×28 cm (8½×11 in.) and were mounted to 1 mm thick white linerboard with 3M #558 Positionable Mounting Adhesive (3M Company, St. Paul, Minn.). The top surface of the mounted film was then cleaned once with Expo Dry Erase Spray cleaner (Sanford Corp., Bellwood, Ill.) and wiped dry with a paper towel.

Dyne Pen Test for Surface Energy

Dyne pens or surface energy pens are available from UV Process Supply, Inc., Chicago, Ill. The pens came in a set of 8 ranging in surface tension from 30 mJ/m² to 44 mJ/m² in steps of 2 mJ/m². The 30 mJ/m² pen was first applied to the dry erase surface in a continuous line about 5 cm long. Then the next higher surface tension pen was applied to the surface. The writing line of the pen was observed for one minute. The surface energy of the surface was taken as the surface tension of the highest number pen that did not dewet in one minute.

60 Degree Gloss Test

Gloss at 60 degrees was measured on a BYK Gardner Gloss-Haze meter available from BYK Gardner, Columbia, Md. The instrument was first verified to be in calibration with a standard white gloss tile. The test specimen was a dry erase film mounted on fiberboard with 3M #558 PMA tape. Three measurements of gloss were made on each specimen and the average of the three measurements was reported.

Writing on Surface with Markers

Dry erase surfaces were marked with 18 different markers comprising 7 brands of dry erase and 2 brands of permanent markers. The dry erase markers were Avery Marks-A-Lot (Avery-Dennison, Pasadena, Calif.), Boone Screamers (Boone International, Corona, Calif.), Boone Low Odor (Boone International), Dixon Dry Erase (Dixon Ticonderoga Co., Heathrow, Fla.), Expo Bold (Sanford Corp., Bellwood, Ill.), Expo 2 (Sanford Corp.), and Liquid Expo (Sanford Corp.). The permanent markers were Sharpie (Sanford Corp.) and Avery Marks-A-Lot (Avery-Dennison) brands. The markers all had a wide or chisel point. Two colors of marker from each brand were chosen including black if available. It was noted that within the same brand of dry erase marker, some colors were more difficult to remove than others. A typical dry erase sample was about the size of a sheet of paper. For each marker brand a horizontal space about 2.5 cm high on the sample was reserved for that marker brand. The first marker was used to write the marker brand name on the left hand side of the 2.5 cm high space and the second marker was used to write the same marker brand name on the right hand side of the 2.5 cm high space. In this manner, all the writing from each marker brand is lined up in one erasable horizontal line. The name of the marker was written on the film to more easily determine if the marker was completely erased.

Time Aging of Marker Writing

Time aging of the marker writing was accomplished by letting the sample sit for two weeks at approximately 22 degrees C. (72 degrees F.) in an office environment. Humidity was not specifically controlled, however, the office was air conditioned in the summer.

Heat Aging of Marker Writing

After writing on the dry erase surface, the writing was allowed to dry for one hour before putting the sample in a bench top laboratory oven. The sample was heat aged for 48 hours at 55 degrees C. (130 degrees F.).

Marker Wettability Test

After marking the surface of the dry erase article and aging, each marker was examined for evidence of dewetting. Dewetting of the writing was evidenced by the appearance of holes in the writing or a shrinkage of the characteristic writing line. The total number of markers that have evidence of dewetting was calculated. Because there are 18 different markers in the writing test, the range of possible dewetting scores is 0-18. For example, if no markers dewet, the dewetting score is zero.

Dry Erase Marker Removal

After writing on the sample and aging, removability of dry erase writing was tested as follows. The sample was placed on a hard, flat surface. An Expo brand dry eraser (Sanford Corp.) was used to erase the writing. The area of the eraser in contact with the sample was about 12.5 cm×5 cm. Steady hand pressure of about 5.2 kgf (8.1 KPa) was maintained on the eraser as it was passed over the first line of marker writing. The first line of writing included the writing from the two markers of the first brand. The number of firm eraser strokes required to remove all but a few specs of marker writing were counted. In many cases a single stroke of the eraser removed all the writing. In other cases it took ten or more strokes to remove the writing. Counting of strokes was stopped after all the writing was completely erased or when additional strokes did not remove any more writing. For some markers, the eraser did not remove all of the writing. If some writing remained on the surface, water was applied to a paper towel. The number of strokes of the wet towel required to completely remove the writing was counted. If the wet towel did not remove the all the writing, Windex window cleaner (S.C. Johnson Co., Racine, Wis.) and a paper towel were applied to the surface to remove it. If the Windex cleaner did not remove all the writing, Expo dry erase spray cleaner was sprayed on the surface and wiped with a paper towel. The total number of strokes of each cleaning procedure were added together to give a number for each line of marker writing. Then the total number of strokes for each of the 7 lines of dry erase marker writing were added to give the dry erase score. The minimum dry erase removal score is 7 (because there were a total of 7 lines of dry erase marker writing).

Permanent Marker Removal

The permanent marker test was performed only after the dry erase marker removal test was complete to avoid smearing the dry erase markers with spray cleaner. With the sample on a flat surface, some Expo dry erase cleaner was sprayed directly on the permanent marker writing. The writing was then cleaned with a paper towel. The spray and clean cycle was repeated several times until either the sample was clean or no more of the permanent marker writing was removed. There were 4 permanent markers on the sample. If any ghost image of the permanent marker remained on the surface, it was counted as a failure and the score for that marker was zero. The total number of permanent markers completely cleaned from the surface was the permanent marker score. The range of possible permanent marker removal scores is 0-4. For example, if no permanent marker was removed from the sample, the permanent marker removal score would be 0.

Mandrel Bend Test for Flexibility

The mandrel bend test was adapted from ASTM D3111, “Standard Test Method for Flexibility Determation of Hot-Melt Adhesives by Mandrel Bend Test Method”. The test specimens were the uncoated and coated substrates cited in the examples. The specimens were cut into sheets of about 20 by 25 mm. Smaller specimens can also be tested. Each sheet was wrapped 180 degrees around a metal rod or mandrel within 1 second. If the specimen was coated, the coated side of the specimen was on the outside of the mandrel. Three mandrel diameters were available for this test, 6.4 mm (¼ in), 4.8 mm (3/16 in), and 3.2 mm (⅛ in). The specimen was then removed from the mandrel and examined with a 4× eyepiece or a microscope. Failure of the mandrel bend test was evidenced by the appearance of visible fracture, crazing, or cracking of the coating or the substrate or debonding of the coating from the substrate.

Nanoindenter Test for Hardness

Hardness was measured with a Nanoindenter XP (MTS Systems Corporation, Eden Prairie, Minn.). Prior to testing, samples were cut into one centimeter squares and mounted on 50 mm diameter aluminum cylinders which served as fixtures in the Nano XP translation stage. The samples were fixed to the aluminum cylinder by double stick tape. For all experiments, a diamond Berkovich probe was used. The nominal loading rate was set at 10 nm/s with spatial drift set point set at 0.05 nm/s maximum. The probe was forced against the sample at a constant strain rate of 0.05/s to a depth of 200 nm. The regions to be characterized were located while viewing the sample on a video screen with 100× magnification. The test regions were selected to insure that each region was representative of the desired sample material, i.e. free of voids, inclusions, or debris. Furthermore, microscope optical axis to indenter axis alignment was checked and calibrated previous to testing by an iterative process where test indentations were made into a fused quartz standard, with error correction provided by software in the XP.

The sample surface was located via a surface find function in which the probe approaches the surface with a spring stiffness that changes significantly when the surface is encountered. Once the probe was at the surface, load-displacement data was acquired as the probe indented the surface. This data was then transformed to hardness based on the equations below. The experiment was repeated in seven different areas of the sample and then averaged. For each indentation test, plots of load vs. displacement, hardness vs. depth, and elastic modulus vs. depth were generated. Hardness data was also averaged over a penetration depth of 100-150 nm.

Hardness, H, is defined as:

H=P/A,

where P is the applied load on the sample and A is the projected area of contact of the sample with the indenter probe. The units of hardness are megapascals (MPa). A discussion of the theory of instrumented indentation testing and Hardness determination can be found in Chapter 4 of the MTS TestWorks 4 Software for Nanoindentation Systems (MTS Systems).

Table of Components

| Acro- | | | |
|---|---|---|---|
| nym | Description | Manufacturer | Location |
| Irgacure | UV photoinitiator | Ciba Specialty | Tarrytown, NY |
| 184 | | Chemicals | |
| Darocure | UV photoinitiator | Ciba Specialty | Tarrytown, NY |
| 1173 | | Chemicals | |
| FC-4430 | Fluorochemical | 3M Company | St. Paul, MN |
| | surfactant | | |
| Nalco | 20 nm colloidal silica | Ondeo Nalco | Naperville, IL |
| 2327 | dispersion | Company | |
| A174 | 3-(trimethoxysilyl | Aldrich Chemical | Milwaukee, WI |
| | propyl) methacrylate | Co. | |
| HDDA | 1,6 hexanediol | Sartomer | Exton, Pa |
| | diacrylate | | |
| PETA | Pentaerythritol | Sartomer | Exton, Pa |
| | tetraacrylate | | |
| Prostab | Hindered amine nitroxide | Ciba Specialty | Tarrytown, NY |
| 5198 | | Chemicals | |
| SR444 | Pentaerythritol triacrylate | Sartomer | Exton, Pa |
| Z-6040 | 3-(trimethoxysilyl | Dow Coring | Midland, MI |
| | propyl) methacrylate | | |
| DMA | N,N-dimethyl acrylamide | Aldrich Chemical | Milwaukee, WI |
| | | Co. | |
| | Phenothiazine | Aldrich Chemical | Milwaukee, WI |
| | | Co. | |
| BHT | Butylated | Aldrich Chemical | Milwaukee, WI |
| | hydroxytoluene | Co. | |
| Tinuvin | UV stabilizer | Ciba Specialty | Tarrytown, NY |
| 292 | | Chemicals | |

### Example 1

78.5 g of pentaerythritol triacrylate, 31.2 g of Dow Corning Z-6030 silane coupling agent, 19.5 g of N,N-dimethyl acrylamide, 17.5 mg of phenothiazine and 15.9 mg of butylated hydroxytoluene (BHT) were weighed into a flask. The mixture was stirred for approximately 30 minutes until all reagents were completely dissolved. Upon addition of 255 g of Nalco 2327 (40% aqueous dispersion of colloidal silica with a pH of 9.3; ammonium stabilized), the solution became a milky white suspension. The resin flask was sealed and a 24 cm distillation column and 500 mL receiving flask, cooled to −78° C. with a dry ice/acetone bath, were attached. A thermocouple was placed in the reaction mixture to monitor the reaction temperature. Vacuum was slowly applied to the apparatus through the distillation head until reaching a pressure of 10 torr. The temperature of the mixture was slowly increased, causing the distillation of water from the suspension. As the distillation proceeded and the distillation of water was nearly complete the mixture changed from a milky white suspension to a nearly clear solution. Water distillation ceased from the solution when the mixture reached approximately 50° C. Because of the high viscosity of the solution, approximately 195 g of the curable composition product were recovered from the resin flask. The curable composition product was diluted to 50% solids by the addition of 195 g of isopropyl alcohol. To the above curable composition was added 3.9 g of Irgacure 184.

The solution was coated on clear 0.1 mm (4 mil) thick PVDC primed polyester film made by 3M Company, St. Paul, Minn. The solution was coated with a #6 Meyer rod on 23 cm wide film. Handspreads were dried in air for 2 min. to remove the solvent. The coated film was then exposed to a UV H bulb at 1500 W/cm (600 W/in) with a nitrogen purge to crosslink the coating on a moving belt at a speed of 12 n/min (40 fpm).

### Example 2

400 g of Nalco 2327 colloidal silica dispersion was charged into a quart jar. Next, 450 g of 1-methoxy-2-propanol and 25.4 g of A174 silane coupling agent were mixed together and added to the colloidal dispersion while stirring. The jar was sealed and heated to 80 degrees C. for 16.5 hr. This resulted in a white, high viscosity solution of modified silica. A 1 L round-bottom flask was charged with 520.8 g of the above modified sol. 73.4 g of 1,6 hexanediol diacrylate, 73.4 g of pentaerythritol tetracrylate and 0.058 g of Prostab 5198 were added to the flask. Water and alcohol were removed via rotary evaporation under vacuum. A clear, low viscosity liquid was obtained. To this solution was added 2.44 g of Darocure 1173 and 1.0 g of FC-4430.

The solution was coated on a laboratory coater on 23 cm wide, 0.1 mm thick, primed polyester film available from 3M Company. The coating method was reverse gravure with a 10 BCM volume factor QCH pattern gravure cylinder. The web speed was 15 m/min. The coated film was cured by passing the web under a UV H bulb at 1000 W/cm (400 W/in) with a nitrogen purge.

### Example 3

500 g of Nalco 2327 colloidal silica was concentrated at 55 degrees C. in a roto-evaporator to 300 g. The concentrate was diluted with 1200 g of n-propanol and the solution obtained added over a period of 30 min. to the still pot of a distillation apparatus containing 900 g of refluxing n-propanol. There distilled an azeotrope of water and n-propanol at 88 degrees C. Distillation was continued until the still head temperature increased to 97 degrees C. To 800 g of 20.5 wt. % solids dispersion of particles made in n-propanol were added 12.4 g of Irgacure 184, 10.3 g of Tinuvin 292, 40.6 g of N,N-dimethyl acrylamide, and 261.1 g of SR444 resin. The solution was coated as described in Example 1.

TABLE 1
Test results from examples.

| | | Example # | | |
|---|---|---|---|---|
| | | 1 | 2 | 3 |
| Test Method | Units | Hardcoat 1 | Hardcoat 2 | Hardcoat 3 |
| Hardness | MPa | 726 | 616 | 588 |
| Mandrel Bend | 6.4 mm | Pass | Pass | Pass |
| | mandrel | | | |
| Mandrel Bend | 4.8 mm | Pass | Pass | Pass |
| | mandrel | | | |
| Mandrel Bend | 3.2 mm | Pass | Pass | Pass |
| | mandrel | | | |
| Gloss, 60 degrees | Gloss | 121 | 119 | 113 |
| | units | | | |
| Marker Dewetting | No. of | 0 | 0 | 0 |
| | pens | | | |
| Dry erase | No. of | 11 | 12 | 7 |
| Time Aging | strokes | | | |
| Dry erase | No. of | 10 | 11 | 9 |
| Heat Aging | strokes | | | |
| Permanent | No. of | 4 | 4 | 4 |
| Marker, Time aging | pens | | | |

Various modifications and alterations of this invention will become apparent to those skilled in the art without departing from the scope and spirit of this invention, and it should be understood that this invention is not to be unduly limited to the illustrated embodiments set forth herein.

What is claimed is:

1. A method of making an erasable article comprising:
providing an electret film having first and second opposed major surfaces; applying a polymerizable precursor composition to at least a portion of the first major surface;
polymerizing the polymerizable precursor composition to form a non-tacky crosslinked polymeric layer; and
exposing the electret film and non-tacky crosslinked polymeric layer to a direct current corona discharge,
wherein the second major surface is free of adhesive material.

2. The method of claim 1, wherein the non-tacky crosslinked polymeric layer has a thickness in a range of from about 0.5 micrometers to about 20 micrometers.

3. The method of claim 1, wherein the non-tacky crosslinked polymeric layer has a thickness in a range of from about 1 micrometers to about 14 micrometers.

4. The method of claim 1, wherein the non-tacky crosslinked polymeric layer has a thickness in a range of from about 1 micrometers to about 8 micrometers.

5. The method of claim 1, wherein the non-tacky crosslinked polymeric layer has a scratch hardness of at least about 4H.

6. The method of claim 1, wherein the non-tacky crosslinked polymeric layer has a scratch hardness of at least about 6H.

7. The method of claim 1, wherein the exposed non-tacky crosslinked polymeric layer surface has a roughness Ra of less than about 50 nanometers.

8. The method of claim 1, wherein the exposed non-tacky crosslinked polymeric layer surface has a roughness Ra of less than about 5 nanometers.

9. The method of claim 1, wherein polymerizable precursor composition comprises polymerizable material and curative.

10. The method of claim 1, wherein the polymerizable material comprises polyacrylate.

11. The method of claim 9, wherein the curative comprises photoinitiator.

12. The method of claim 1, wherein the electret film is opaque.

13. The method of claim 1, wherein the electret film is transparent or translucent.

14. The method of claim 1, wherein the electret film is a single layer.

15. The method of claim 1, wherein the electret film comprises at least one of polypropylene or a poly(ethylene-co-methacrylic acid) ionomer.

16. The method of claim 1, wherein the electret film comprises a zinc poly(ethylene-co-methacrylic acid) ionomer.

17. The method of claim 1, wherein the electret film further comprises phosphorescent pigment.

18. The method of claim 1, further comprising an ink layer disposed between the non-tacky crosslinked polymeric layer and the electret film.

19. The method of claim 18, wherein the ink layer further comprises phosphorescent pigment.

20. An erasable article comprising an electret film having first and second opposed major surfaces, and a non-tacky crosslinked polymeric layer comprising contacting the first major surface, wherein the non-tacky crosslinked polymeric layer comprises colloidal silica, and wherein the second major surface is free of adhesive material.

21. An erasable article prepared according to the method of claim 1.

22. An erasable article comprising an electret film having first and second opposed major surfaces, and a non-tacky crosslinked polymeric layer comprising contacting the first major surface, wherein the second major surface is free of adhesive material, and wherein the erasable article forms a roll.

23. A stack comprising a plurality of erasable articles superimposed on each other, wherein each erasable article comprises:
an electret film having first and second opposed major surfaces, and a non-tacky crosslinked polymeric layer comprising contacting the first major surface, wherein the second major surface is free of adhesive material.

24. An erasable article comprising:
an electret film having first and second opposed major surfaces, and a non-tacky crosslinked polymeric layer contacting the first major surface, wherein the electret film and wherein the second major surface is free of adhesive material; and
a liner, wherein the liner contacts the second major surface.

25. The erasable article of claim 24, wherein the electret film is a single layer.

26. The erasable article of claim 24, wherein the substrate is selected from the group consisting of an architectural surface, an appliance, a window, and fabric.

27. A kit comprising:
an erasable article, wherein the erasable article comprises:
an electret film having a first major surface and a second major surface; and
a non-tacky crosslinked polymeric layer; and
at least one of a marker, eraser, or liquid cleaner.

28. The kit of claim 27, wherein the erasable article further comprises a liner.

29. The kit of claim 27, wherein the marker comprises an aqueous ink.

30. A dry erase article comprising:
a flexible sheet having a first surface;
a first coating layer disposed on the first surface having a hardness upon curing of greater than about 500 MPa
a writing surface disposed on the first coating layer suitable for receiving dry erase ink; and
wherein the first coating layer has minimal effect on the flexibility of the sheet.

31. The dry erase article of claim 30 wherein the ink receptive surface has a surface energy of at least about 25 mJ/m².

32. The dry erase article of claim 30 wherein the substrate and the secured first coating layer have a level of flexibility such that the substrate and the secured first coating layer can be bent 180 degrees around a 6.4 mm diameter mandrel without any visible signs of cracking or fracture of the substrate or the first coating layer or debonding of the first coating layer from the substrate.

33. The dry erase article of claim 30 wherein the substrate and the secured first coating layer have a level of flexibility such that the substrate and the secured first coating layer can be bent 180 degrees around a 3.2 mm diameter mandrel without any visible signs of cracking or fracture of the substrate or the first coating layer or debonding of the first coating layer from the substrate.

34. The dry erase article of claim 30 wherein the sheet is selected from the group consisting of: polymeric film, extrusion coated paper, paper film laminate, coated paper, uncoated paper, and flexible metal.

35. The dry erase article of claim 30 wherein the first coating layer has a thickness of about 1 to about 15 micrometers.

36. The dry erase article of claim 30 wherein the first coating layer preferably has a thickness of about 1 to about 10 micrometers.

37. The dry erase article of claim 30 wherein the first coating layer further comprises:
at least one ethylenically unsaturated monomer; and
colloidal inorganic oxide particles.

38. The dry erase article of claim 37 wherein the colloidal inorganic oxide particles have an average particle diameter of less than about 1 micrometer.

39. The dry erase article of claim 37 wherein the first coating layer further comprises:
an ultraviolet photoinitiator.

40. The dry erase article of claim 30 wherein the first coating layer is curable by ultraviolet, electron beam, or thermal radiation.

41. The dry erase article of claim 30, and further comprising:
a second coating layer disposed between the first coating layer and the flexible sheet.

42. The dry erase article of claim 41, wherein the second coating layer includes printed indicia.

43. The dry erase article of claim 30 wherein the flexible sheet includes a second surface and further comprising:
a second coating layer disposed on the second surface.

44. The dry erase article of claim 43 wherein the second coating layer is adhesive.

45. The dry erase article of claim 30 wherein the first coating layer has a hardness upon curing of greater than about 600 MPa.

46. The dry erase article of claim 30 wherein the first coating layer has a hardness upon curing of greater than about 700 MPa.

47. The dry erase article of claim 30 wherein the 60 degree gloss value of the writing surface is greater than 50 gloss units.

48. The dry erase article of claim 30 wherein the first coating layer has less and 10% by weight of additives.

49. A dry erase article comprising:
a substrate having a first surface and a second surface;
a curable hardcoat layer secured to the first surface, the hardcoat layer including at least one ethylenically unsaturated monomer, colloidal inorganic oxide particles; and
a writing surface disposed on the curable hardcoat layer suitable for receiving dry erase marker ink, the writing surface having a 60 degree gloss value of greater than 50 gloss units.

50. The dry erase article of claim 49 wherein the curable hardcoat composition comprises a curing initiator.

51. The dry erase article of claim 50 wherein the curing initiator comprises an ultraviolet photoinitiator.

52. The dry erase article of claim 49, wherein the colloidal inorganic oxide particles are silica particles.

53. The dry erase article of claim 49, wherein the colloidal silica particles have an average diameter of about 5 to about 1000 nm.

54. The dry erase article of claim 49, wherein the colloidal silica particles have an average diameter of about 5 to about 100 nm.

55. The dry erase article of claim 49, wherein the colloidal silica particles comprise from about 5 to about 50 weight percent of the coating composition excluding solvents.

56. The dry erase article of claim 49 wherein the curable hardcoat further comprises an organofunctional silane coupling agent.

57. The dry erase article of claim 56 wherein said the organofunctional silane coupling agent comprises a hydrolyzable organofunctional silane.

58. The dry erase article of claim 56, wherein the coupling agent comprises 3-(trimethoxysilyl)propylmethacrylate, 3-(triethoxysilyl)propylmethacrylate, or a mixture thereof.

59. The dry erase article of claim 56, wherein the coupling agent comprises about 1 to about 15 weight percent of the hardcoat composition.

60. The dry erase article of claim 49 wherein the ethylenically unsaturated monomer comprises at least one trifunctional or higher functionality ethylenically unsaturated monomer or combinations thereof.

61. The dry erase article of claim 49 wherein the ethylenically unsaturated monomer comprises at least one monofunctional or difunctional ethylenically unsaturated monomer or combinations thereof.

62. The dry erase article of claim 61 wherein the monofunctional ethylenically unsaturated monomer comprises an amide containing compound.

63. The dry erase article of claim 49, wherein the monofunctional amide-containing compound is selected from the group consisting of N,N-disubstituted acetamides, N,N-disubstituted formamides, N,N-disubstituted acrylamides, N-substituted pyrolidinones, N-substituted formamides, N-substituted caprolactams, and combinations thereof.

64. The radiation curable hardcoat composition of claim 49, wherein the monofunctional or difunctional ethylenically unsaturated monomer comprises about 1 to about 80 weight percent of the hardcoat composition.

65. The dry erase article of claim 49 wherein the trifunctional or higher functionality ethylenically unsaturated monomer is pentaerythritol triacrylate or pentaerythritol tetracrylate, the difunctional ethylenically unsaturated monomer is hexanediol diacrylate, the monofunctional ethylenically unsaturated monomer is N,N-dimethyl acrylamide, the organofunctional silane coupling agent is (meth)acryloxypropyl trimethoxysilane, and the colloidal inorganic oxide particles comprise silica.

66. The dry erase article of claim 49, wherein the colloidal silica particles have an average diameter of about 5 to about 1000 nm.

67. The dry erase article of claim 49, wherein the colloidal silica particles have an average diameter of about 5 to about 100 nm.

68. The dry erase article of claim 49 wherein the curable hardcoat layer is a coatable UV hardcoat solution at 100% solids.

69. The dry erase article of claim 49 wherein the substrate is selected from the group consisting of: a polymeric sheet, polymeric film, extrusion coated paper, paper film laminate, coated paper, uncoated paper, metal film, and metal sheet.

70. The dry erase article of claim 49 wherein the hardcoat layer has a thickness from about 1 micrometer to about 15 micrometers.

71. The dry erase article of claim 49 wherein the first coating layer preferably has a thickness of about 1 to about 10 micrometers.

72. The dry erase article of claim 49 wherein the writing surface has a surface energy of at least 25 mJ/m².

73. The dry erase article of claim 49 wherein the hardcoat layer has less than 10% by weight of additives.

74. A method for forming a dry erase article in a continuous process comprising:
applying a curable hardcoat coating to a streaming or moving web of a flexible substrate;
curing the coating at a curing station, wherein the cured coating had a hardness of 500 MPa or greater as measured by a nanoindenter; and
forming a writing surface on the hardcoat coating suitable for receiving dry erase ink.

75. The method of claim 74 wherein the substrate is selected from a group consisting of: a polymeric film, extrusion coated paper, paper film laminate, coated paper, uncoated paper, and flexible metal.

76. The method of claim 74 wherein the hardcoat coating has a thickness of from about 1 micrometer to about 15 micrometers

77. The dry erase article of claim 74 wherein the first coating layer preferably has a thickness of about 1 to about 10 micrometers.

78. The method of claim 74 wherein the hardcoat coating is comprised of at least one multifunctional acrylate monomer, and colloidal inorganic oxide particles.

79. The dry erase article of claim 78 wherein the hardcoat layer further comprises a curing initiator.

80. The dry erase article of claim 78 wherein the curing initiator is further comprised of a UV photoinitiator.

81. The method of claim 74 wherein after curing, the writing surface has a surface energy of at least 25 mJ/m².

82. The method of claim 74 wherein the step of curing the hardcoat coating further comprises:
emitting radiation at the hardcoat coating.

83. The method of claim 74 wherein the radiation is selected from the group consisting of: ultraviolet radiation, electron beam, and thermal radiation.

84. The method of claim 74 and further comprising:
drying the hardcoat coating on the flexible substrate.
